(19) United States
(12) Patent Application Publication
(10) Pub. No.: US 2013/0293556 A1
(43) Pub. Date: Nov. 7, 2013

(54) APPARATUS FOR POSITIONING INTERFEROMETRIC MODULATOR BASED ON PROGRAMMABLE MECHANICAL FORCES

(71) Applicants: Edward K. Chan, San Diego, CA (US); John H. Hong, San Clemente, CA (US); Bing Wen, Poway, CA (US)

(72) Inventors: Edward K. Chan, San Diego, CA (US); John H. Hong, San Clemente, CA (US); Bing Wen, Poway, CA (US)

(73) Assignee: QUALCOMM MEMS Technologies, Inc., San Diego, CA (US)

(21) Appl. No.: 13/463,606

(22) Filed: May 3, 2012

(51) Int. Cl. G02B 26/00; G06T 1/00

(52) U.S. Cl. 345/501; 359/291

(57) ABSTRACT

Interferometric modulators may include a movable layer including both permanently anchored and programmable hinges. Unactuated programmable hinges may exert little or no force on the movable layer. When actuated, programmable hinges may exert a mechanical force on the movable layer in a direction approximately opposite to the direction of force exerted by the permanently anchored hinges. By increasing a voltage between the programmable hinges and an electrode, a progressive number of programmable hinges may be engaged. The mechanical force exerted on the movable layer by these hinges may change the relative position of the movable layer within an IMOD device.

### TECHNICAL FIELD

This disclosure relates to interferometric modulators. Specifically, the disclosure relates to an apparatus that utilizes variable mechanical structures to determine the interferometric gap in an interferometric modulator.

### DESCRIPTION OF THE RELATED TECHNOLOGY

Electromechanical systems (EMS) include devices having electrical and mechanical elements, actuators, transducers, sensors, optical components (such as mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

The position of one plate in relation to another in current designs of interferometric modulators may be determined by a combination of forces exerted on one or more of the plates. Some of these forces may be mechanical and some may be electrostatic forces. For example, when no voltage potential is present in the IMOD device, a plate's relative position, within a gap for example, may be determined by the mechanical forces caused by the attachment points of the plate and the structural properties of the material comprising the plate. When the IMOD is in a non-actuated state, the mechanical forces reach an equilibrium that results in a non-actuated or first equilibrium position for the plate.

When the IMOD device is in an active state, a voltage potential across one or more of the plates may result in an electrostatic force between plates of the interferometric modulator. This electrostatic force may cause an attractive force between the plates, which may counteract some of the mechanical forces present when the IMOD is in a non-actuated state to cause the plates to move closer to each other. When the plates are at a certain distance apart and a lower (smaller) electrostatic force attractive force is created between the plates. The plates move further apart. The plate or plates may move until a new second equilibrium position is reached that balances the electrostatic force with existing mechanical forces.

The second equilibrium position of the IMOD plates may vary based on a number of factors. For example, manufacturing tolerances in the thickness or material composition of the plates of an IMOD device may change the precise amount of mechanical force exerted by the plate attachment points and plate structure described above. Voltage differences from one IMOD device to another may also increase or decrease the electrostatic force present within each IMOD device. For example, IMOD devices closer to a voltage source may experience slightly higher electrostatic forces while IMOD devices electrically further from a voltage source, due to resistance loses, may experience slightly less electrostatic force. These variations in mechanical and electrostatic forces may cause small differences in the relative positions of a set of IMOD devices included in a display panel. These variations may reduce the overall quality of an image displayed on a display panel that includes IMOD devices using the design discussed above.

Current designs of analog IMODs may also have difficulty placing a first plate in an position that is within a threshold distance of a second plate or substrate. With some AIMOD device designs, when the distance between the two plates is below a threshold distance, a large portion of (or all of) the first plate may snap down and contact the second plate. With these designs, while non-actuated and partially engaged positions may be implemented, the physical tendency of the first plate materials to snap down and contact the second plate may prevent positioning of the first plate within the threshold distance of the second plate. This may limit the ability of the AIMOD design to display particular colors.

### SUMMARY

The systems, methods and devices of the disclosure each have several innovative aspects, no single one of which is solely responsible for the desirable attributes disclosed herein.

One innovative aspect of the subject matter described in this disclosure can be implemented in an electromechanical apparatus. The apparatus includes a movable reflective layer with at least two opposing edges, the reflective layer including at least two cantilevers, at least one cantilever extending from each of the at least two opposing edges, and one or more electrodes for attracting the at least two cantilevers such that when a voltage is applied to the one or more electrodes, an electrostatic force moves the cantilevers toward an engagement surface and the cantilevers thereby exert a mechanical force on the movable reflective layer.

In some implementations of the apparatus, the movable layer is configured to move within a gap, with a position of the movable layer within the gap determining the color of light reflected from the electromechanical apparatus. In some other implementations of the apparatus, the apparatus also includes an absorbing layer, and the reflective layer is configured to move within a gap disposed between the reflective layer and the absorbing layer. A distance between the reflective layer and the absorbing layer determines color of light reflected from the apparatus. In some implementations the apparatus may also include a plurality of supports, and at least one hinge connected to the reflective layer and to at least one of the plurality of supports, with the reflective layer held at a position by at the least one hinge. In some of these implementations, the device is configured such that the position of the reflective layer within the gap is determined, at least temporarily, by a balance of mechanical forces exerted by the at least one hinge and at least one of the cantilevers.

In some implementations of the apparatus, the apparatus also includes an analog interferometric modulator capable of having three or more states, the analog interferometric modulator including the movable reflective layer and the one or more electrodes. In some implementations of apparatus also includes a main electrode for actuating the movable reflective layer. In some implementations, the reflective layer is substantially rectangular shaped and includes four edges, and the at least two cantilevers extend from at least two of the edges of the reflective layer.

In some implementations, the apparatus is configured such that a first cantilever is configured to contact the engagement surface upon application of a first voltage between the first cantilever and a first electrode, and a second cantilever is configured to contact the engagement surface upon the application of a second voltage across the second cantilever and a second electrode. The first voltage is lower than the second voltage in some implementations. In some other implementations, the first electrode and the second electrode are the same electrode.

In some implementations, a first contact point on a first cantilever is configured to contact the engagement surface when a first voltage is applied across an electrode and the first cantilever, and a second contact point on the first cantilever is configured to contact the engagement surface when a second voltage is applied across the electrode and the first cantilever. In some of these implementations the first contact point is between the second contact point and an end of the cantilever distal to the reflective layer, and the first voltage is lower than the second voltage.

In some other implementations of the apparatus, the mechanical layer includes at least four cantilevers, and at least two cantilevers extend from at least two of the opposing edges. In some other implementations of the apparatus, the apparatus also includes an electronic display, and a processor that is configured to communicate with the electronic display.

The processor is configured to process image data. The apparatus also includes a memory device that is configured to communicate with the processor. In some of these implementations, the processor is configured to determine an engagement characteristic of one or more cantilevers. In some of these implementations, the processor determines which of the one or more cantilevers will engage with the one or more electrodes or a degree of a cantilever's engagement with an electrode. Some of the implementations also include a driver circuit configured to send at least one signal to the display.

In some implementations of the apparatus, the movable layer is configured to be positioned at three or more discrete distances from an electrode. Some of the implementations also include a controller configured to send at least a portion of the image data to the driver circuit. They may also include an image source module configured to send the image data to the processor. In some of these implementations, the image source module includes at least one of a receiver, transceiver, and transmitter. Some implementations of the apparatus include an input device configured to receive input data and to communicate the input data to the processor.

Another innovative aspect disclosed is a method of displaying information. The method includes applying a first voltage across a first electrode and a movable reflective layer to move the movable layer through a gap to a position relative to an absorbing layer, and applying a second voltage across a second electrode and a cantilever extending from the reflective layer to move the cantilever toward an engagement surface.

In some of these implementations, the position of the reflective layer in the gap determines the color of light reflected from an electromechanical device. In some implementations of the method, application of the first voltage is stopped while continuing to apply the second voltage.

Another innovative aspect disclosed is an electromechanical apparatus. The apparatus includes means for applying a first voltage to a movable reflective layer to move the movable layer through a gap to a position relative to an absorbing layer, and means for applying a second voltage to a cantilever extending from the reflective layer to move the cantilever toward an engagement surface. In some implementations of this apparatus, the first voltage applying means includes a first electrode and a first actuation circuit, and the first actuation circuit electrically is connected to the first electrode and the reflective layer. In some implementations of the apparatus, the second voltage applying means includes a second electrode and a second actuation circuit, and the second actuation circuit is electrically connected to the second electrode and the cantilever.

Another innovative aspect disclosed is a non-transitory, computer readable storage medium having instructions stored thereon that cause a processing circuit to perform a method. The method includes applying a first voltage across a first electrode and a movable reflective layer to move the movable layer through a gap to a position relative to an absorbing layer, and applying a second voltage across a second electrode and a cantilever extending from the reflective layer to move the cantilever toward an engagement surface. In some of these implementations, the method also includes stopping application of the first voltage while continuing to apply the second voltage.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1A and 1B show examples of isometric views depicting a pixel of an interferometric modulator (IMOD) display device in two different states.

FIG. 2 shows an example of a schematic circuit diagram illustrating a driving circuit array for an optical MEMS display device.

FIG. 3 shows an example of a schematic partial cross-section illustrating one implementation of the structure of the driving circuit and the associated display element of FIG. 2.

FIG. 4 shows an example of a schematic exploded partial perspective view of an optical MEMS display device having an interferometric modulator array and a backplate with embedded circuitry.

FIG. 5 shows a cross-section of an interferometric modulator having two fixed layers and a movable third layer.

FIG. 6 shows an example of a schematic circuit diagram illustrating a driving circuit array for an optical EMS display device having the structure of FIG. 5.

FIGS. 7A-7C show cross-sections of the two fixed layers and the movable layer of the interferometric modulator of FIG. 5 illustrating stacks of materials.

FIG. 8 shows a schematic representation of the interferometric modulator and voltage sources illustrated in FIG. 5.

FIG. 9A shows an example of a cross-section of an analog IMOD (AIMOD).

FIG. 9B shows an example of a cross-section of an analog IMOD (AIMOD) according to another implementation.

FIG. 10A shows an example implementation of a movable layer within a MEMS device.

FIGS. 10B-10F show how a movable layer within an interferometric modulator may be positioned at different locations within an IMOD device.

FIGS. 10G-J illustrate plan view schematics of four implementations of a main electrode and programmable hinge electrodes.

FIG. 10K is a flowchart of a method for displaying information.

FIG. 11A shows an example implementation of a movable layer for an interferometric modulator including anchor hinges and one or more programmable hinges.

FIG. 11B illustrates the non-actuated positioning of one implementation of a movable layer relative to a visual path in some implementations of an IMOD device 1140.

FIG. 11C illustrates the positioning of one implementation of a movable layer relative to a visual path when programmable hinges of the movable layer are engaged by two electrodes.

FIGS. 12A-12D show an example implementation of a movable layer within an interferometric modulator that includes a plurality of programmable (or variable) hinges.

FIGS. 13A-13D show an example implementation of a movable layer that includes programmable hinges providing multiple anchor points per hinge.

FIG. 14 shows an example implementation of a movable layer providing programmable hinges with multiple anchor points per hinge.

FIG. 15A shows multiple different anchor points within a programmable hinge.

FIG. 15B shows the relative displacement of a movable layer when engaging different anchor points within a programmable hinge.

FIG. 16 is an example system block diagram illustrating a visual display device 40 including a plurality of interferometric modulators.

FIGS. 17A and 17B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (such as video) or stationary (such as still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (such as e-readers), computer monitors, auto displays (such as an odometer display), cockpit controls and/or displays, camera view displays (such as a display connected to a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (such as a display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Various implementations include apparatus that provide a movable layer within an interferometric modulator device. The movable layer may be reflective or may be partially reflective and/or partially transmissive of light. The relative position of the movable layer within a gap of the interferometric modulator may determine the wavelength of light reflected by the interferometric modulator (IMOD). The movable layer in the disclosed implementations may be positioned within the gap by the balance of mechanical forces exerted by hinges attached to or formed from the movable layer. Some of the hinges of the movable layer may be permanently anchored to structure of the IMOD device. For example, in some implementations, support posts may be included in the IMOD device. In some implementations, two support posts may be provided on opposing sides of a movable layer. Hinges may extend from these opposing sides and permanently attach to the support posts. Some implementations may instead utilize four support posts. In these implementations, the movable layer may also include four edges or sides, with each edge or side adjacent to each support post. Alternatively, four corners of a movable layer may include hinges that anchor to support posts adjacent to the corners.

The movable layer may also include one or more programmable or variable hinges, which may also be referred to as cantilevers. Programmable hinges may extend from one or more edges of the movable layer. The IMOD device including the movable layer and one or more programmable hinges may also include corresponding programmable hinge electrodes for actuating the programmable hinges. An anchor point may function to engage the programmable hinge in that the programmable hinge may be attracted to the programmable hinge electrode based on an electrostatically attractive force. In some implementations, a single electrode may function as an anchor point for all the programmable hinges that are associated with a movable layer. In other implementations, more than one programmable hinge electrode may be used to electrostatically attract and hold the programmable hinges towards an engagement surface. In some implementations, the programmable hinges may contact the engagement surface. In these implementations, the programmable hinges may include a dielectric coating to prevent an electric current flow when the programmable hinges contact the engagement surface. In some implementations, an IMOD device may include an electrode for attracting the movable layer and one or more electrodes for attracting one or more programmable hinges.

While an electrostatic force may cause the programmable hinges to be attracted to one or more electrodes, in some implementations, the programmable hinges may not physically contact the electrodes. Nor do the programmable hinges become electrically shorted to the one or more electrodes. Instead, when the programmable hinges are engaged with one or more electrodes or anchor points, an electrical gap may be maintained between the programmable hinges and the electrodes.

When no voltage is applied to the programmable hinge or the programmable hinge electrode, the programmable hinges may be physically detached from their corresponding anchor point. Such a configuration may be referred to as an unactuated state of the hinge. When unactuated, the programmable hinges may exert little or no mechanical force on the movable layer. For example, the mechanical force caused only by the weight of the programmable hinge may be present when no voltage is applied. When a voltage potential is applied between a programmable hinge and a corresponding programmable hinge electrode, the programmable hinge may be engaged with its anchor point. In some implementations, the programmable hinge may contact its anchor point or engagement surface. This engagement may be caused by an electrostatic force between the programmable hinge and the anchor point caused by the applied voltage.

While an engaged programmable hinge may be fully extended towards its anchor point, it may not physically contact the anchor point or it may contact the anchor point but be insulated from electrical contact through a dielectric layer on either the programmable hinge or the anchor point. If the programmable hinge were to make electrical contact with its anchor point, the electrical contact between the hinge and electrode would reduce the electrostatic force between the hinge and electrode.

Once actuated, the programmable hinge may apply a mechanical force on the movable layer in the approximate direction of the corresponding anchor point. In other words, once the hinge is actuated it may pull the movable layer in a direction at least generally towards the anchor point, depending on the specific configuration of the hinge and the anchor point.

The mechanical forces provided by one or more programmable hinge and the mechanical forces provided by one or more permanently anchored hinges contribute to move the movable layer to a position where equilibrium between the mechanical and electrostatic forces is achieved.

Particular implementations of the subject matter described in this disclosure can be implemented to realize one or more of the following potential advantages. Some implementations of the disclosed apparatus may provide for more consistent and reliable positioning of movable layers within an interferometric modulator when compared to current analog IMOD designs, for example, IMOD designs where the movable layer is moved from a non-actuated state to a semi-actuated or fully-actuated state based on electrostatic forces between the movable layer and a stationary electrode.

Current designs of analog IMODs may also have difficulty placing a first plate in an position that is within a threshold distance of a second plate or substrate. With some AIMOD device designs, when the distance between the two plates is below a threshold distance, a large portion of (or all of) the first plate may snap down and contact the second plate. With these designs, while non-actuated and partially engaged positions may be implemented, the physical tendency of the first plate materials to snap down and contact the second plate may prevent positioning of the first plate within the threshold distance of the second plate. This may limit the ability of the AIMOD design to display particular colors.

The disclosed AIMOD designs may provide an improved ability to position a reflective layer at multiple discrete distances from an electrode. Because the disclosed designs provide for a progressive application of a mechanical force to a movable layer, the tendency for the moveable layer to snap down as in prior art designs may be reduced. This may provide more reliable reproduction of a color gamut when compared to traditional designs as described above.

Electronic displays utilizing the IMOD apparatus disclosed herein may also be more efficient in their use of electrical power than known IMOD display devices. In some known IMOD devices, electrostatic attraction between a stationary electrode and a movable electrode provides the only force for actuating the IMOD. In the disclosed design, a balance of mechanical forces between permanently anchored hinges and programmable hinges may be used to position the movable layer of the IMOD. Because less voltage is used to maintain the relative position of movable layers of the disclosed IMOD devices, less power may be consumed during the hold state of the IMOD devices. This may increase the battery life in power sensitive devices, such as mobile telephones.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

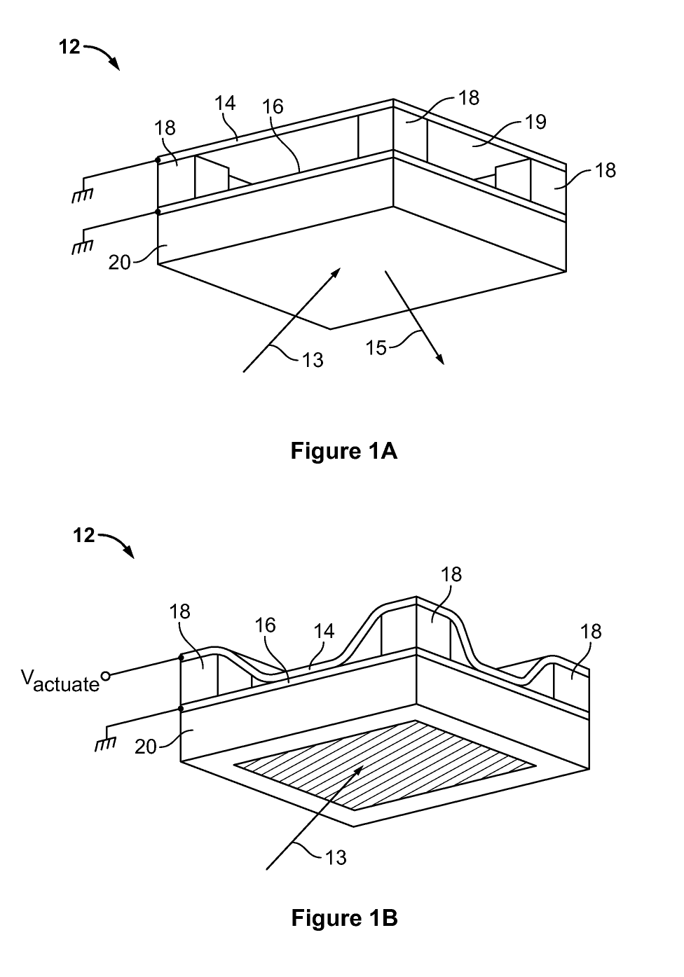

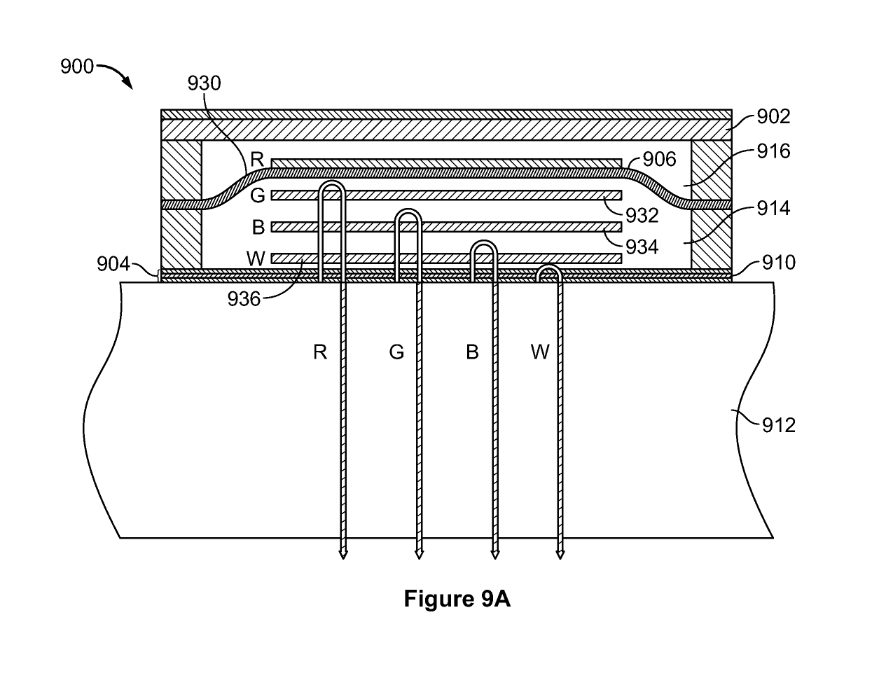

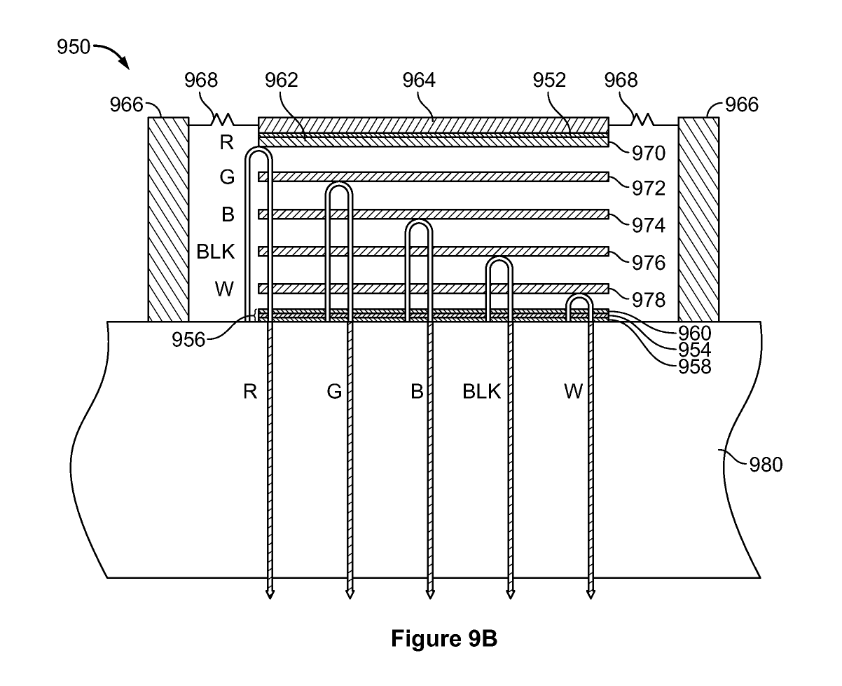

FIGS. 1A and 1B show examples of isometric views depicting a pixel of an interferometric modulator (IMOD) display device in two different states. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white. As described in FIGS. 9A and 9B, in other implementations IMOD display elements can be configured to have three or more different states, each state causing the IMOD display element to reflect light having a different spectrum of wavelengths.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted pixels in FIGS. 1A and 1B depict two different states of an IMOD 12. In the IMOD 12 of FIG. 1A, a movable reflective layer 14 is illustrated in a relaxed position at a predetermined distance from an optical stack 16, which includes a partially reflective layer. Since no voltage is applied across the IMOD 12 in FIG. 1A, the movable reflective layer 14 remained in a relaxed or unactuated state. In the IMOD 12 of FIG. 1B, the movable reflective layer 14 is illustrated in an actuated position adjacent to the optical stack 16. The voltage V_{actuate} applied across the IMOD 12 in FIG. 1B is sufficient to actuate the movable reflective layer 14 to an actuated position.

In FIGS. 1A and 1B, the reflective properties of pixels 12 are generally illustrated with arrows 13 indicating light incident upon the pixels 12, and light 15 reflecting from the pixel 12 on the left. A person having ordinary skill in the art will readily recognize that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixels 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can include a layer of materials having light absorbing properties, for example, chromium (Cr) and vanadium (V). The partially reflective layer may also include a layer of molybdenum (Mo) or molybdenum-chromium (MoCr). These layers can have a thickness dimension of less than 10 nm. The partially reflective layer can be formed from a variety of materials that are partially reflective. These materials include various metals, such as chromium (Cr), semiconductors, and dielectrics. The partially reflective layer can be formed of one or more layers of materials, and each of the layers can be formed of a single material or a combination of materials or of metal alloys. In some implementations, the optical stack 16 can include a single semi-transparent thickness of metal or semiconductor which serves as both an optical absorber and conductor, while different, electrically more conductive layers or portions, such as the optical stack 16 or other structures of the IMOD) can serve to bus signals between IMOD pixels. The optical stack 16 also can include one or more insulating or dielectric layers covering one or more conductive layers or an electrically conductive/optically absorptive layer.

In some implementations, the lower electrode 16 is grounded at each pixel. In some implementations, this may be accomplished by depositing a continuous optical stack 16 onto the substrate and grounding the entire sheet at the periphery of the deposited layers. In some implementations, a highly conductive and reflective material, such as aluminum (Al), may be used for the movable reflective layer 14. The movable reflective layer 14 may be formed as a metal layer or layers deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be approximately less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14a remains in a mechanically relaxed state, as illustrated by the pixel 12 in FIG. 1A, with the gap 19 between the movable reflective layer 14 and optical stack 16. However, when a potential difference or voltage is applied to at least one of the movable reflective layer 14 and optical stack 16, the capacitor formed at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 in FIG. 1B. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

In some implementations, the optical stacks 16 in a series or array of IMODs can serve as a common electrode that provides a common voltage to one side of the IMODs of the display device. The movable reflective layers 14 may be formed as an array of separate plates arranged in, for example, a matrix form, as described further below. The separate plates can be supplied with voltage signals for driving the IMODs.

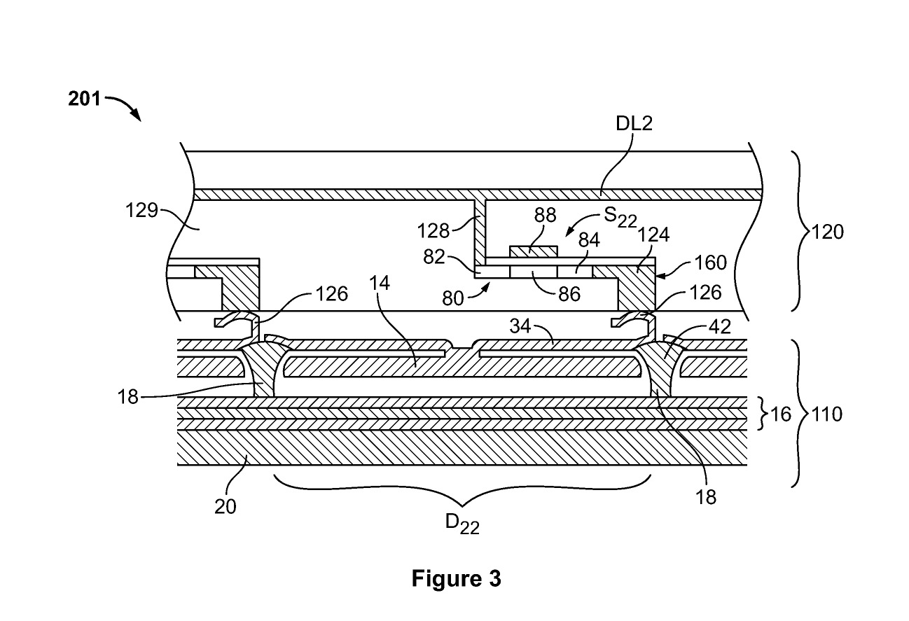

The details of the structure of interferometric modulators that operate in accordance with the principles set forth above may vary widely. For example, the movable reflective layers 14 of each IMOD may be attached to supports at the corners only. As shown in FIG. 3, a flat, relatively rigid reflective layer 14 may be suspended from a deformable layer 34, which may be formed from a flexible metal. This architecture allows the structural design and materials used for the electromechanical aspects and the optical aspects of the modulator to be selected, and to function, independently of each other. Thus, the structural design and materials used for the reflective layer 14 can be optimized with respect to the optical properties, and the structural design and materials used for the deformable layer 34 can be optimized with respect to desired mechanical properties. For example, the reflective layer 14 portion may be aluminum, and the deformable layer 34 portion may be nickel. The deformable layer 34 may connect, directly or indirectly, to the substrate 20 around the perimeter of the deformable layer 34. These connections may form the support posts 18.

In implementations such as those shown in FIGS. 1A and 1B, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 3) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing.

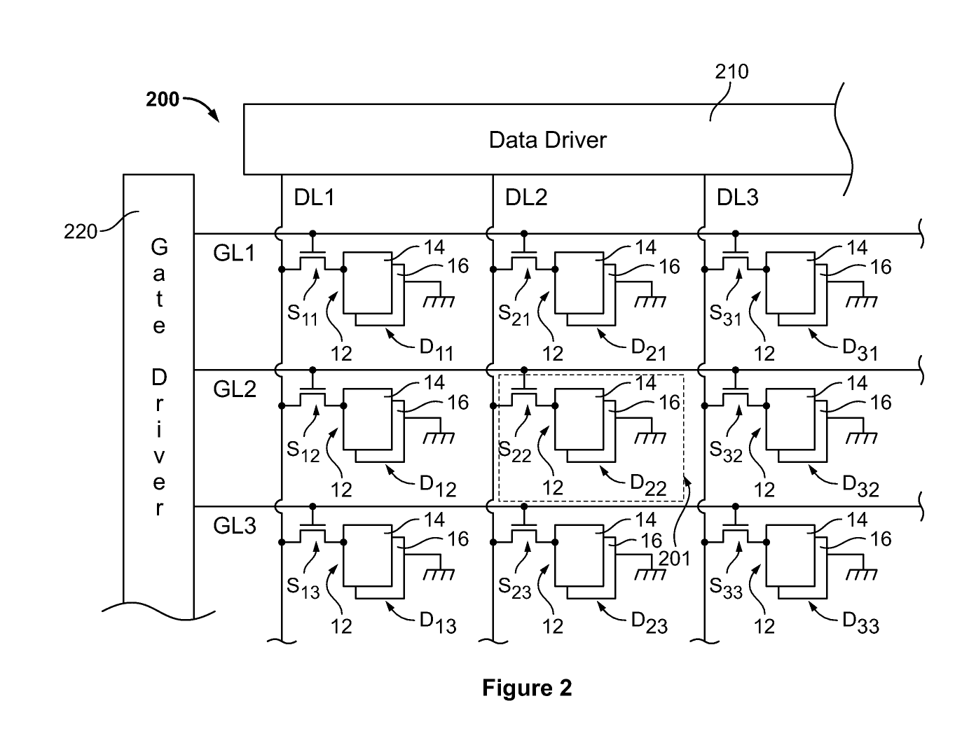

FIG. 2 shows an example of a schematic circuit diagram illustrating a driving circuit array 200 for an optical MEMS display device. The driving circuit array 200 can be used for implementing an active matrix addressing scheme for providing image data to display elements D₁₁-Dₘₙ of a display array assembly. In at least some implementations of active matrix addressing, the row signal drives the gate of a transistor switch at each pixel and the IMOD is connected to the source of the transistor and the remaining IMOD electrode can be grounded. Active matrix addressing can have a much higher frame rate capability because the pixels can be connected to the column lines through the transistor, avoiding cross-talk and large capacitances that can be seen in passive matrix implementations.

The driving circuit array 200 includes a data driver 210, a gate driver 220, first to m-th data lines DL1-DLm, first to n-th gate lines GL1-GLn, and an array of switches or switching circuits S₁₁-Sₘₙ. Each of the data lines DL1-DLm extends from the data driver 210, and is electrically connected to a respective column of switches S₁₁-S₁ₙ, S₂₁-S₂ₙ, . . . , Sₘ₁-Sₘₙ. Each of the gate lines GL1-GLn extends from the gate driver 220, and is electrically connected to a respective row of switches S₁₁-Sₘ₁, S₁₂-Sₘ₂, . . . , S₁ₙ-Sₘₙ. The switches S₁₁-Sₘₙ are electrically coupled between one of the data lines DL1-DLm and a respective one of the display elements D₁₁-Dₘₙ and receive a switching control signal from the gate driver 220 via one of the gate lines GL1-GLn. The switches S₁₁-Sₘₙ are illustrated as single FET transistors, but may take a variety of forms such as two transistor transmission gates (for current flow in both directions) or even mechanical MEMS switches.

The data driver 210 can receive image data from outside the display, and can provide the image data on a row by row basis in a form of voltage signals to the switches S₁₁-Sₘₙ via the data lines DL1-DLm. The gate driver 220 can select a particular row of display elements D₁₁-Dₘ₁, D₁₂-Dₘ₂, D₁ₙ-Dₘₙ by turning on the switches S₁₁-Sₘ₁, S₁₂-Sₘ₂, . . . , S₁ₙ-Sₘₙ associated with the selected row of display elements D₁₁-Dₘ₁, D₁₂-Dₘ₂, . . . , D₁ₙ-Dₘₙ. When the switches S₁₁-Sₘ₁, S₁₂-Sₘ₂, . . . , S₁ₙ-Sₘₙ in the selected row are turned on, the image data from the data driver 210 is passed to the selected row of display elements D₁₁-Dₘ₁, D₁₂-Dₘ₂, D₁ₙ-Dₘₙ.

During operation, the gate driver 220 can provide a voltage signal via one of the gate lines GL1-GLn to the gates of the switches S₁₁-Sₘₙ in a selected row, thereby turning on the switches S₁₁-Sₘₙ. After the data driver 210 provides image data to all of the data lines DL1-DLm, the switches S₁₁-Sₘₙ of the selected row can be turned on to provide the image data to the selected row of display elements D₁₁-Dₘ₁, D₁₂-Dₘ₂, . . . , D₁ₙ-Dₘₙ, thereby displaying a portion of an image. For example, data lines DL that are associated with pixels that are to be actuated in the row can be set to 10-volts (could be positive or negative), and data lines DL that are associated with pixels that are to be released in the row can be set to O-volts. Then, the gate line GL for the given row is asserted, turning the switches in that row on, and applying the selected data line voltage to each pixel of that row. This charges and actuates the pixels that have 10-volts applied, and discharges and releases the pixels that have O-volts applied. Then, the switches S₁₁-Sₘₙ can be turned off. The display elements D₁₁-Dₘ₁, D₁₂-Dₘ₂, D₁ₙ-Dₘₙ can hold the image data because the charge on the actuated pixels will be retained when the switches are off, except for some leakage through insulators and the off state switch. Generally, this leakage is low enough to retain the image data on the pixels until another set of data is written to the row. These steps can be repeated to each succeeding row until all of the rows have been selected and image data has been provided thereto. In the implementation of FIG. 2, the lower electrode 16 is grounded at each pixel. In some implementations, this may be accomplished by depositing a continuous optical stack 16 onto the substrate and grounding the entire sheet at the periphery of the deposited layers. FIG. 3 is an example of a schematic partial cross-section illustrating one implementation of the structure of the driving circuit and the associated display element of FIG. 2.

FIG. 3 shows an example of a schematic partial cross-section illustrating one implementation of the structure of the driving circuit and the associated display element of FIG. 2. The portion 201 of the driving circuit array 200 includes the switch S₂₂ at the second column and the second row, and the associated display element D₂₂. In the illustrated implementation, the switch S₂₂ includes a transistor 80. Other switches in the driving circuit array 200 can have the same configuration as the switch S₂₂.

FIG. 3 also includes a portion of a display array assembly 110, and a portion of a backplate 120. The portion of the display array assembly 110 includes the display element D₂₂ of FIG. 2. The display element D₂₂ includes a portion of a front substrate 20, a portion of an optical stack 16 formed on the front substrate 20, supports 18 formed on the optical stack 16, a movable electrode 14 supported by the supports 18, and an interconnect 126 electrically connecting the movable electrode 14 to one or more components of the backplate 120.

The portion of the backplate 120 includes the second data line DL2 and the switch S₂₂ of FIG. 2, which are embedded in the backplate 120. The portion of the backplate 120 also includes a first interconnect 128 and a second interconnect 124 at least partially embedded therein. The second data line DL2 extends substantially horizontally through the backplate 120. The switch S₂₂ includes a transistor 80 that has a source 82, a drain 84, a channel 86 between the source 82 and the drain 84, and a gate 88 overlying the channel 86. The transistor 80 can be a thin film transistor (TFT) or metal-oxide-semiconductor field effect transistor (MOSFET). The gate of the transistor 80 can be formed by gate line GL2 extending through the backplate 120 perpendicular to data line DL2. The first interconnect 128 electrically couples the second data line DL2 to the source 82 of the transistor 80.

The transistor 80 is coupled to the display element D₂₂ through one or more vias 160 through the backplate 120. The vias 160 are filled with conductive material to provide electrical connection between components (for example, the display element D₂₂) of the display array assembly 110 and components of the backplate 120. In the illustrated implementation, the second interconnect 124 is formed through the via 160, and electrically couples the drain 84 of the transistor 80 to the display array assembly 110. The backplate 120 also can include one or more insulating layers 129 that electrically insulate the foregoing components of the driving circuit array 200.

As shown in FIG. 3, the display element D₂₂ can be an interferometric modulator that has a first terminal coupled to the transistor 80, and a second terminal coupled to a common electrode that can be formed by at least part of an optical stack 16. The optical stack 16 of FIG. 3 is illustrated as three layers, a top dielectric layer described above, a middle partially reflective layer (such as chromium) also described above, and a lower layer including a transparent conductor (such as indium-tin-oxide (ITO)). The common electrode is formed by the ITO layer and can be coupled to ground at the periphery of the display.

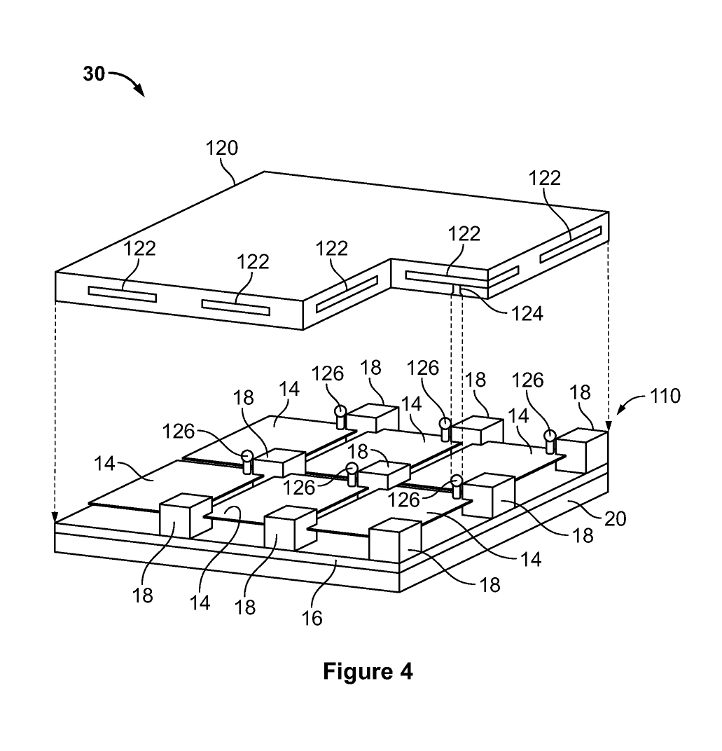

FIG. 4 shows an example of an exploded partial perspective view of an optical MEMS display device 30 having an interferometric modulator array and a backplate with embedded circuitry. The display device 30 includes a display array assembly 110 and a backplate 120. In some implementations, the display array assembly 110 and the backplate 120 can be separately pre-formed before being attached together. In some other implementations, the display device 30 can be fabricated in any suitable manner, such as, by forming components of the backplate 120 over the display array assembly 110 by deposition.

The display array assembly 110 can include a front substrate 20, an optical stack 16, supports 18, movable electrodes 14, and interconnects 126. The backplate 120 includes backplate components 122 at least partially embedded therein, and one or more backplate interconnects 124.

The optical stack 16 of the display array assembly 110 can be a substantially continuous layer covering at least the array region of the front substrate 20. The optical stack 16 can include a substantially transparent conductive layer that is electrically connected to ground. The movable electrodes 14 can be separate plates having, e.g., a square or rectangular shape. The movable electrodes 14 can be arranged in a matrix form such that each of the movable electrodes 14 can form part of a display element. In the implementation of FIG. 4, the movable electrodes 14 are supported by the supports 18 at four corners.

Each of the interconnects 126 of the display array assembly 110 serves to electrically couple a respective one of the movable electrodes 14 to one or more backplate components 122. In the illustrated implementation, the interconnects 126 of the display array assembly 110 extend from the movable electrodes 14, and are positioned to contact the backplate interconnects 124. In another implementation, the interconnects 126 of the display array assembly 110 can be at least partially embedded in the supports 18 while being exposed through top surfaces of the supports 18. In such an implementation, the backplate interconnects 124 can be positioned to contact exposed portions of the interconnects 126 of the display array assembly 110. In yet another implementation, the backplate interconnects 124 can extend to and electrically connect to the movable electrodes 14 without actual attachment to the movable electrodes 14, such as the interconnects 126 of FIG. 4.

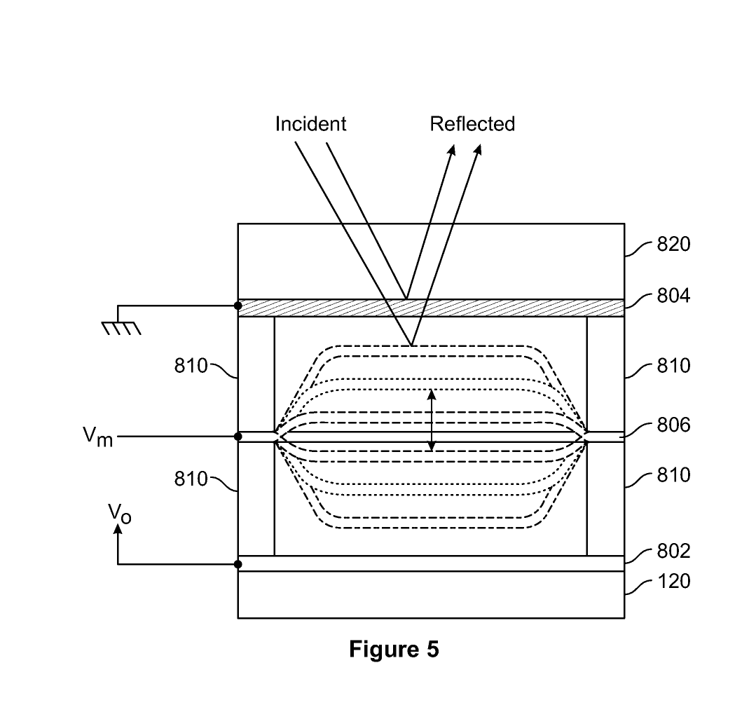

In addition to the bistable interferometric modulators described above, which have a relaxed state and an actuated state, interferometric modulators may be designed to have a plurality of states. For example, an analog interferometric modulator (AIMOD) may have a range of color states. In one AIMOD implementation, a single interferometric modulator can be actuated into, e.g., a red state, a green state, a blue state, a black state, and/or a white state. More generally speaking, an AIMOD can be considered any interferometric modulator with three or more separate color states corresponding to three or more different gap heights. For example, one color state may correspond to a relaxed state (or non-actuated state), while another color state may correspond to a fully actuated state. Additionally, the AIMOD may be capable of having one or more intermediate states between a relaxed and fully actuated state. The color states may include a white color state. In some implementations, as shown in FIG. 5, the AIMOD may be capable of being reverse actuated. Accordingly, a single interferometric modulator may be configured to have various states with different light reflectance properties over a wide range of the optical spectrum. The optical stack of an AIMOD may differ from the bi-stable display elements described above. These differences may produce different optical results. For example, in the bi-stable elements described above, the closed state in some implementations gives the bi-stable element a black reflective state. An analog interferometric modulator, however, may have a white reflective state when the electrodes are in a similar position to the closed state of the bi-stable element.

FIG. 5 shows a cross-section of an interferometric modulator having two fixed layers and a movable third layer. Specifically, FIG. 5 shows an implementation of an analog interferometric modulator having a fixed first layer 802, a fixed second layer 804, and a movable third layer 806 positioned between the fixed first and second layers 802 and 804. Each of the layers 802, 804, and 806 may include an electrode or other conductive material. For example, one of the first and the second layer 802, 804 may include a metal and be fully reflective, while another of the first and the second layer 802, 804 may include an absorber. The absorber may include Mo, Cr, MoCr, or V. As illustrated, the first layer 802 serves as a reflector, and the AIMOD is configured to be viewed through the substrate 820. In other implementations, the AIMOD is an inverse AIMOD and is configured to be viewed on a side opposite the substrate. Each of the layers 802, 804, and 806 may be stiffened using a stiffening layer formed on or deposited on the respective layer. In one implementation, the stiffening layer includes a dielectric. The stiffening layer may be used to keep the layer to which it is attached rigid and substantially flat. Some implementations of the modulator 800 may be referred to as a three-terminal interferometric modulator.

The three layers 802, 804, and 806 are electrically insulated by insulating posts 810. The movable third layer 806 is suspended from the insulating posts 810. The movable third layer 806 is configured to deform such that the movable third layer 806 may be displaced in a generally upward direction toward the first layer 802, or may be displaced in a generally downward direction toward to the second layer 804. In some implementations, the first layer 802 also may be referred to as the top layer or top electrode. In some implementations, the second layer 804 also may be referred to as the bottom layer or bottom electrode. The interferometric modulator 800 may be supported by a substrate 820.

In FIG. 5, the movable third layer 806 is illustrated as being in an equilibrium position with the solid lines. As illustrated in FIG. 5, a fixed voltage difference may be applied between the first layer 802 and the second layer 804. In this implementation, a voltage V₀ is applied to layer 802 and layer 804 is grounded. If a variable voltage Vₘ is applied to the movable third layer 806, then as that voltage Vₘ approaches V₀, the movable third layer 806 will be electrostatically pulled toward grounded layer 804. As that voltage Vₘ approaches ground (0 V), the movable third layer 806 will be electrostatically pulled toward layer 802. If a voltage at the midpoint of these two voltages (V₀/2 in this implementation) is applied to movable third layer 806, then the movable third layer 806 will be maintained in its equilibrium position indicated with solid lines in FIG. 5. By applying a variable voltage to the movable third layer 806 that is between the voltages on the outer layers 802 and 804, the movable third layer 806 can be positioned at a desired location between the outer layers 802 and 804, producing a desired optical response. The voltage difference V₀ between the outer layers can vary widely depending on the materials and construction of the device, and in many implementations may be in the range of about 5-20 volts. It also may be noted that as the movable third layer 806 moves away from this equilibrium position, it will deform or bend. In such a deformed or bent configuration, an elastic spring force mechanically biases the movable third layer 806 toward the equilibrium position. This mechanical force also contributes to the final position of the movable third layer 806 when a voltage V is applied.

The movable third layer 806 may include a mirror to reflect light entering the interferometric modulator 800 through substrate 820. The mirror may include a layer with a metal or metal alloy. The second layer 804 may include a partially absorbing material such that the second layer 804 acts as an absorbing layer. When light reflected from the mirror is viewed from the side of the substrate 820, the viewer may perceive the reflected light as a certain color. By adjusting the position of the movable third layer 806, certain wavelengths of light may be selectively reflected.

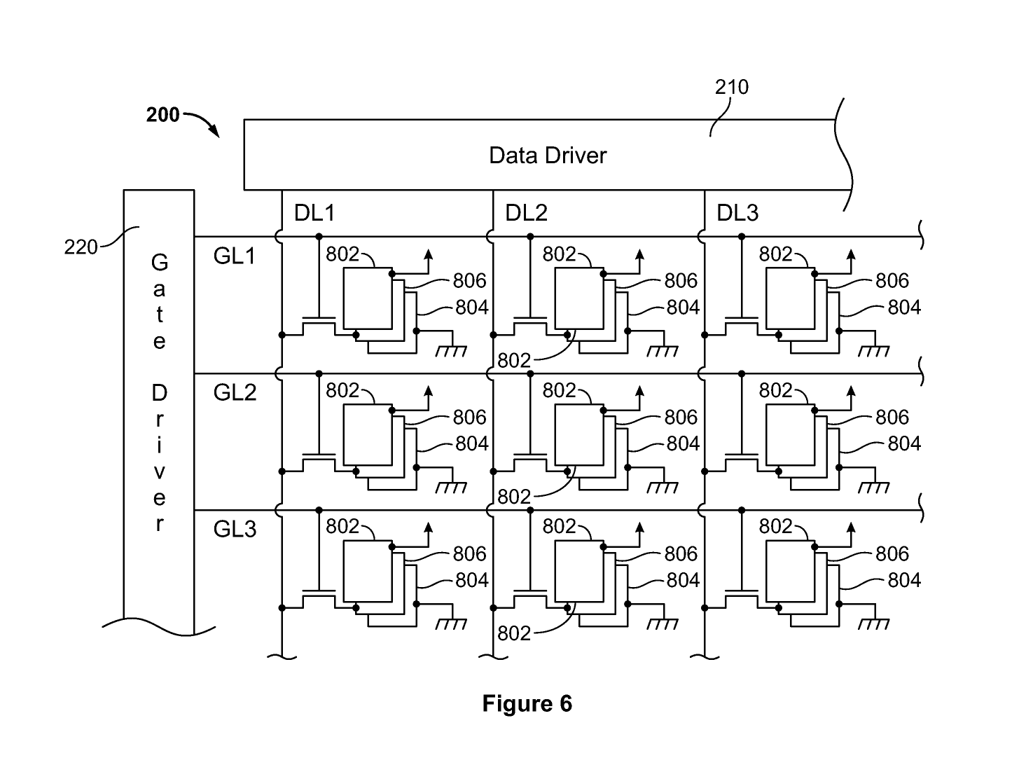

FIG. 6 shows an example of a schematic circuit diagram illustrating a driving circuit array for an optical EMS display device having the structure of FIG. 5. The overall apparatus shares many similarities to the structure of FIG. 2 that uses the bistable interferometric modulators. As shown in FIG. 6, however, an additional upper layer 802 is provided for each display element. This upper layer 802 may be deposited on the underside of the backplate 120 shown in FIGS. 3 and 4, and may have a voltage V₀ applied thereto. These implementations are driven in a manner similar to that described above with reference to FIG. 2, except the voltages provided on the data lines DL1-DLn can be placed at a range of voltages between V₀ and ground, rather than at one of only two different voltages. In this way, the movable third layers 806 of the display elements along a row each can be independently placed in a multitude of particular desired positions between the upper and lower layers when the row is written by asserting the gate line for that particular row.

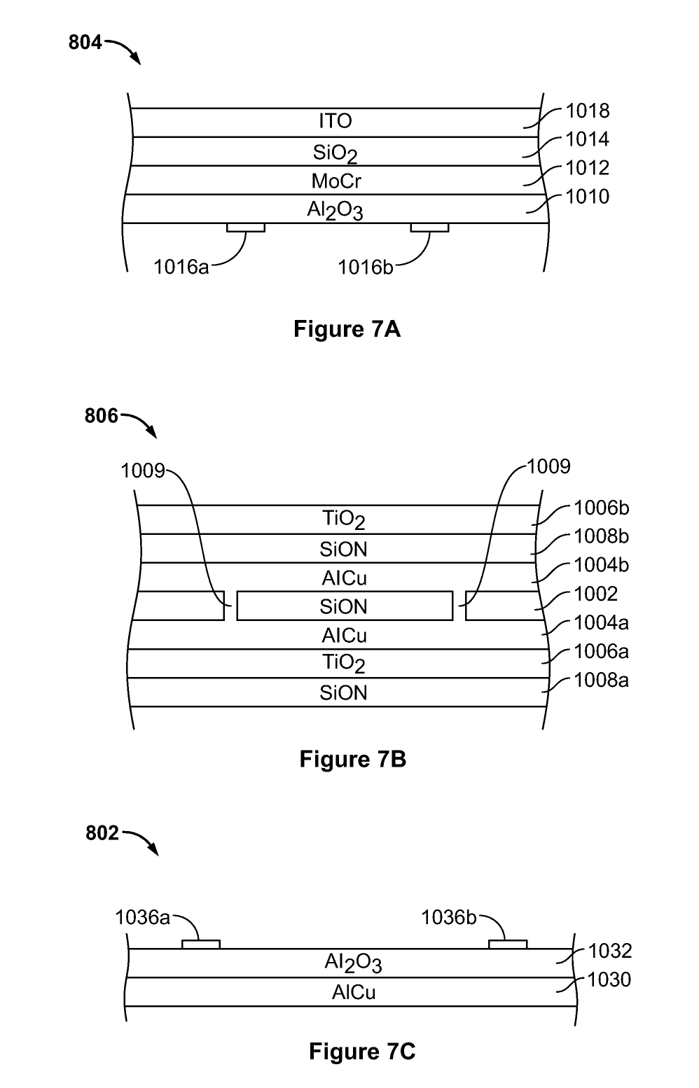

FIGS. 7A-7C show cross-sections of the two fixed layers and the movable layer of the interferometric modulator of FIG. 5 illustrating stacks of materials.

The movable third layer 806 of FIG. 7B and the second layer 804 of FIG. 7A each include a stack of materials. For example, the movable third layer 806 includes a stack including silicon oxynitride (SiON), aluminum-copper (AlCu), and titanium dioxide (TiO₂). The second layer 804, for example, includes a stack including silicon oxynitride (SiON), aluminum oxide (Al₂O₃), molybdenum-chromium (MoCr), and silicon dioxide (SiO2).

In the implementation illustrated in FIG. 7A, the second layer 804 includes a SiO₂ substrate 1014 having a MoCr layer 1012 formed thereon. In this implementation, the MoCr layer 1012 may act as a discharge layer to discharge accumulated charge, and may be coupled to a transistor to selectively affect the discharge. The MoCr layer 1012 also may serve as an optical absorber. In some implementations, the MoCr layer 1012 is approximately 5 nm thick. An Al₂O₃ layer 1010 is formed on the MoCr layer 1012, and may provide some reflectance of light incident thereon and may also serve as a bussing layer in some implementations. In some implementations, the Al₂O₃ layer 1010 is approximately 9 nm thick. One or more SiON stops 1016a and 1016b may be formed on the surface of the Al₂O₃ layer 1014. These stops 1016 mechanically prevent the movable third layer 806 from contacting the Al₂O₃ layer 1010 of the second layer 804 when the movable third layer 806 is deflected fully towards the second layer 804. This may reduce stiction and snap-in of the device. Further, an electrode layer 1018 may be formed on the SiO₂ substrate 1010, as shown in FIG. 7. The electrode layer 1018 may include any number of substantially transparent electrically conductive materials, with indium tin oxide being one suitable material.

In the illustrated implementation, the movable third layer 806 includes a SiON substrate 1002 having an AlCu layer 1004a deposited thereon. In this implementation, the AlCu layer 1004a is conductive and may be used as an electrode. In some implementations, the AlCu layer 1004 provides reflectivity for light incident thereon. In some implementations, the SiON substrate 1002 is approximately 500 nm thick, and the AlCu layer 1004a is approximately 50 nm thick. A TiO₂ layer 1006a is deposited on the AlCu layer 1004a, and in some implementations the TiO₂ layer 1006a is approximately 26 nm thick. An SiON layer 1008a is deposited on the TiO₂ layer 1006a, and in some implementations the SiON layer 1008a is approximately 52 m thick. The refractive index of the TiO₂ layer 1006a is greater than the refractive index of the SiON layer 1008a. Forming a stack of materials with alternating high and low refractive indices in this way may cause light incident on the stack to be reflected, thereby acting substantially as a mirror.

As can be seen in FIG. 7B, the movable third layer 806 may in some implementations include an additional AlCu layer 1004b, an additional TiO₂ layer 1006b, and an additional SiON layer 1008b formed on the side of the SiON substrate 1002 opposite the AlCu layer 1004a, TiO₂ layer 1006a, and SiON layer 1008a. Forming the layers 1004b, 1006b, and 1008b may weight the movable third layer 806 approximately equally on each side of the SiON substrate 1002, which may increase the positional accuracy and stability of the movable third layer 806 when translating the movable third layer 806. In such implementations, a via 1009 or other electrical connection may be formed between the AlCu layers 1004a and 1004b such that the voltage of the two AlCu layers 1004a and 1004b will remain substantially equal. In this way, when a voltage is applied to one of these two layers, the other of these two layers will receive the same voltage. Additional vias (not shown) may be formed between the AlCu layers 1004a and 1004b.

Layer 802 illustrated in FIG. 7C can be made with simple structure as it has fewer optical and mechanical functions compared to layers 804 and 802. This layer may include a conductive layer of AlCu 1030 and an insulating Al₂O₃ layer 1032. As with layer 804, one or more SiON stops 1036a and 1036b may be formed on the surface of the Al₂O₃ layer 1032.

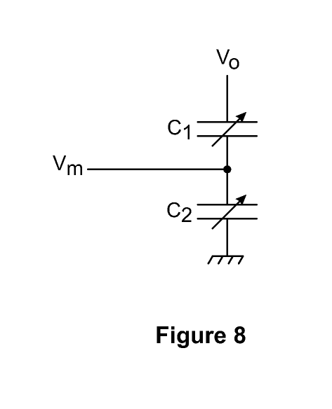

FIG. 8 shows a schematic representation of the interferometric modulator and voltage sources illustrated in FIG. 5. In this schematic, the modulator is coupled to the voltage sources V₀ and Vₘ. Those of skill in the art will appreciate that the gap between the first layer 802 and the movable third layer 806 forms a capacitor C₁ having a variable capacitance, while the gap between the movable third layer 806 and the second layer 804 forms a capacitor C₂ also having a variable capacitance. Thus, in the schematic representation illustrated in FIG. 8, the voltage source V₀ is connected across the series coupled variable capacitors C₁ and C₂, while the voltage source Vₘ is connected between the two variable capacitors C₁ and C₂.

Accurately driving the movable third layer 806 to different positions using the voltage sources V₀ and Vₘ as described above, however, may be difficult with many configurations of the interferometric modulator 800 because the relationship between voltage applied to the interferometric modulator 800 and the position of the movable third layer 806 may be highly non-linear. Further, applying the same voltage Vₘ to the movable layers of different interferometric modulators may not cause the respective movable layers to move to the same position relative to the top and bottom layers of each modulator due to manufacturing differences, for example, variations in thickness or elasticity of the middle layers 806 over the entire display surface. As the position of the movable layer will determine what color is reflected from the interferometric modulator, as discussed above, it is advantageous to be able to detect the position of the movable layer and to accurately drive the movable layer to desired positions.

FIGS. 9A and 9B show examples of a cross-section of an analog IMOD (AIMOD). With reference to FIG. 9A, the AIMOD 900 includes a substrate 912 and an optical stack 904 disposed over the substrate 912. The AIMOD includes a first electrode 910 and a second electrode 902 (as illustrated, the first electrode 910 is a lower electrode, and second electrode 902 is an upper electrode). The AIMOD 900 also includes a movable reflective layer 906 disposed between the first electrode 910 and the second electrode 902. In some implementations, the optical stack 904 includes an absorbing layer, and/or a plurality of other layers. In some implementations, and in the example illustrated in FIG. 9A, the optical stack 904 includes the first electrode 910 which is configured as an absorbing layer. In such a configuration, the absorbing layer (first electrode 910) can be an approximately 6 nm layer of material that includes MoCr. In some implementations, the absorbing layer (i.e., the first electrode 910) can be a layer of material including MoCr with a thickness ranging from approximately 2 nm to 10 nm.

Still referring to FIG. 9A, the reflective layer 906 can be provided with a charge. The reflective layer is configured to, once charged, move toward either the first electrode 910 or the second electrode 902 when a voltage is applied between the first and second electrodes 910 and 902. In this manner, the reflective layer 906 can be driven through a range of positions between the two electrodes 902 and 910, including above and below a relaxed (unactuated) state. For example, FIG. 9A illustrates that the reflective layer 906 can be moved to various positions 930, 932 and 934 and 936 between the first electrode 910 and the second electrode 902.

The AIMOD 900 can be configured to selectively reflect certain wavelengths of light depending on the display state of the AIMOD, where the display state is related to the position of the reflective layer 906, which may also be referred to as a movable layer. The distance between the first electrode 910, which in this implementation acts as an absorbing layer, and the reflective layer 906 changes the reflective properties of the AIMOD 900. Any particular wavelength is maximally reflected from the AIMOD 900 when the distance between the reflective layer 906 and the absorbing layer (first electrode 910) is such that the absorbing layer (first electrode 910) is located at the minimum light intensity of standing waves resulting from interference between incident light and light reflected from the reflective layer 906. For example, as illustrated, the AIMOD 900 is designed to be viewed from the substrate 912 side of the AIMOD (through the substrate 912), i.e., light enters the AIMOD 900 through the substrate 912. Depending on the position of the reflective layer 906, different wavelengths of light are reflected back through the substrate 912, which gives the appearance of different colors. These different colors are also known as native colors.

A position of a movable layer(s) of a display element (such as an AIMOD) at a location such that it reflects a certain wavelength or wavelengths can be referred to a display state. For example, when the reflective layer 906 is in position 930, red wavelengths of light are reflected in greater proportion than other wavelengths and the other wavelengths of light are absorbed in greater proportion than red. Accordingly, the AIMOD 900 appears red and is said to be in a red display state, or simply a red state. Similarly, the AIMOD 900 is in a green display state (or green state) when the reflective layer 906 moves to position 932, where green wavelengths of light are reflected in greater proportion than other wavelengths and the other wavelengths of light are absorbed in greater proportion than green. When the reflective layer 906 moves to position 934, the AIMOD 900 is in a blue display state (or blue state) and blue wavelengths of light are reflected in greater proportion than other wavelengths and the other wavelengths of light are absorbed in greater proportion than blue. When the reflective layer 906 moves to a position 936, the AIMOD 900 is in a white display state (or white state) and a broad range of wavelengths of light in the visible spectrum are substantially reflected such that and the AIMOD 900 appears “grey” or in some cases “silver,” and having low total reflection (or luminance) when a bare metal reflector is used. In some cases increased total reflection (or luminance) can be achieved with the addition of dielectric layers disposed on the metal reflector, but the reflected color may be tinted with blue, green or yellow, depending on the exact position of 936. In some implementations, in position 936, configured to produce a white state, the distance between the reflective layer 906 and the first electrode 910 is between about 0 and 20 nm. It should be noted that one of ordinary skill in the art will readily recognize that the AIMOD 900 can take on different states and selectively reflect other wavelengths of light based on the position of the reflective layer 906, and also based on materials that are used in construction of the AIMOD 900, particularly various layers in the optical stack 904.

The AIMOD 900 in FIG. 9A has two structural cavities, a first cavity 914 between the reflective layer 906 and the optical stack 904, and a second cavity 916 between the reflective layer 906 and the second electrode 902. However, because the reflective layer 906 is reflective and not transmissive, light does not propagate through the reflective layer 906 into the second cavity 916. In addition, the color and/or intensity of light reflected by the AIMOD 900 is determined by the distance between the reflective layer 906 and the absorbing layer (first electrode 910). Accordingly, the AIMOD 900 illustrated in FIG. 9A has one interferometric (absorbing) cavity 914. In contrast, the second cavity 916 is not interferometric.

FIG. 9B shows an example of a cross-section of an analog IMOD (AIMOD) according to another implementation. The AIMOD 950 includes a reflective layer 952 positioned above a first electrode 954 that is also an absorbing layer in an optical stack 956, which can include dielectric layers 958 and 960 positioned over and beneath the first electrode 954. The dielectric layer 958 can include more than one layer; likewise, the dielectric layer 960 also can include more than one layer. In some implementations, and in the example illustrated in FIG. 9B, the reflective layer 952 can function as a second electrode. In some other implementations, a separate electrode structure may be formed under or over the reflective layer 952. In some implementations, the reflective layer 952 can include aluminum (Al). In some implementations, the reflective layer 952 can include reflective materials other than Al. The optical stack 956 also can include an absorbing layer that is not an electrode, and/or a plurality of other layers. In some implementations, and in the example illustrated in FIG. 9B, the first electrode 954 is configured as the absorbing layer. The absorbing layer can be, for example, a 6 nm layer of material that includes MoCr. The reflective layer 952 may be covered with one or more dielectric layers 962 positioned between the reflective layer 952 and the optical stack 956. The function of the dielectric layer 962 is to establish the first null of the standing wave in the cavity about 0-20 nm from the surface of the dielectric layer 962. The dielectric layer 962 is also designed to reduce the separations of the first nulls of different wavelengths for improving the brightness of the white state. The reflective layer 952 can be mounted onto a mechanical layer 964, which is in turn attached to hinges 968. The hinges 968 are in turn connected to posts 966 on either side of the mechanical layer 964. The hinges 968 provide support for the mechanical layer 964, reflective layer 952 and the dielectric layer 962, while still permitting movement of these layers in response to an applied voltage between the first electrode 954 and reflective layer 952, which may serve as a second electrode 952.

With continuing reference to FIG. 9B, the reflective layer 952 can be provided with a charge. The reflective layer is configured to, once charged, move toward the first electrode 954 that is connected to ground. In this manner, the reflective layer 952 can be driven through a range of positions relative to the first electrode 954. For example, FIG. 9B illustrates the reflective layer 952 can be moved to various positions 970, 972, 974, 976 and 978 relative to the first electrode 954.

As discussed with respect to FIG. 9A, the AIMOD 950 can be configured to selectively reflect certain wavelengths of light depending on the gap height of the AIMOD. The distance between the first electrode 954, which in this implementations acts as an absorbing layer, and the reflective layer 952 changes the reflective properties of the AIMOD 950. Any particular wavelength can be maximally reflected by controlling the distance between the reflective layer 952 and the absorbing layer first electrode 954. A high percentage of reflection, or a maximum reflection, can occur when the distance is such that the a null in the standing wave formed by light reflected off the top surface of the reflective layer 952 is located at or near the absorbing layer 954. At this distance, the absorbing layer (first electrode 954) is located at the minimum light intensity of the interference standing waves.

For example, the AIMOD 950 of FIG. 9B is designed to be viewed on the substrate 980 side of the AIMOD. Light enters the AIMOD 950 through the substrate 980. Depending on the position of the reflective layer 952, different wavelengths of light are reflected back through the substrate 980, which gives the appearance of different colors. When a movable layer of a display element is positioned at a location such that it reflects a certain wavelength or wavelengths, the display element can be referred to as having or being in a given display state. For example, in one implementation, when the reflective layer 952 is in position 970, red wavelengths of light are substantially reflected and other wavelengths of light are substantially absorbed by the first electrode 954 (the absorbing layer). Accordingly, the AIMOD 950 appears red and is said to be in a red state or a red display state. Similarly, in one implementation, the AIMOD 950 is in a green display state (or green state) when the reflective layer 952 moves to position 972, where green wavelengths of light are substantially reflected and other wavelengths of light are substantially absorbed. When the reflective layer 952 moves to position 974, in one implementation, the AIMOD 950 is in a blue display state (or blue state) and blue wavelengths of light are substantially reflected and other wavelengths of light are substantially absorbed. When the reflective layer 952 moves to a position 976, in one implementation, the AIMOD 950 is in a black display state (or black state) and a broad range of wavelengths of light in the visible spectrum are substantially absorbed, and visible reflections are thereby minimized, such that the AIMOD 950 appears “black.” When the reflective layer 952 moves to a position 978, in one implementation, the AIMOD 950 is in a white display state (or white state) and a broad range of wavelengths of light in the visible spectrum are substantially reflected such that the AIMOD 950 appears “white.” In some implementations, in position 978, configured to produce a white state, the distance between the reflective layer 952 and the first electrode 954 is between about 0 and 20 nm.

While the AIMOD designs illustrated in FIG. 9A-B may have a limited ability to display particular colors due to the physical tendency of multiple plates of the design to snap together, the AIMOD designs disclosed herein may provide an improved ability to position a reflective layer at multiple discrete distances from an electrode. Because the disclosed designs provide for a progressive application of a mechanical force to a movable layer, the tendency for the moveable layer to snap down as in prior art designs may be reduced. This may provide more reliable reproduction of a color gamut when compared to traditional designs as described above.

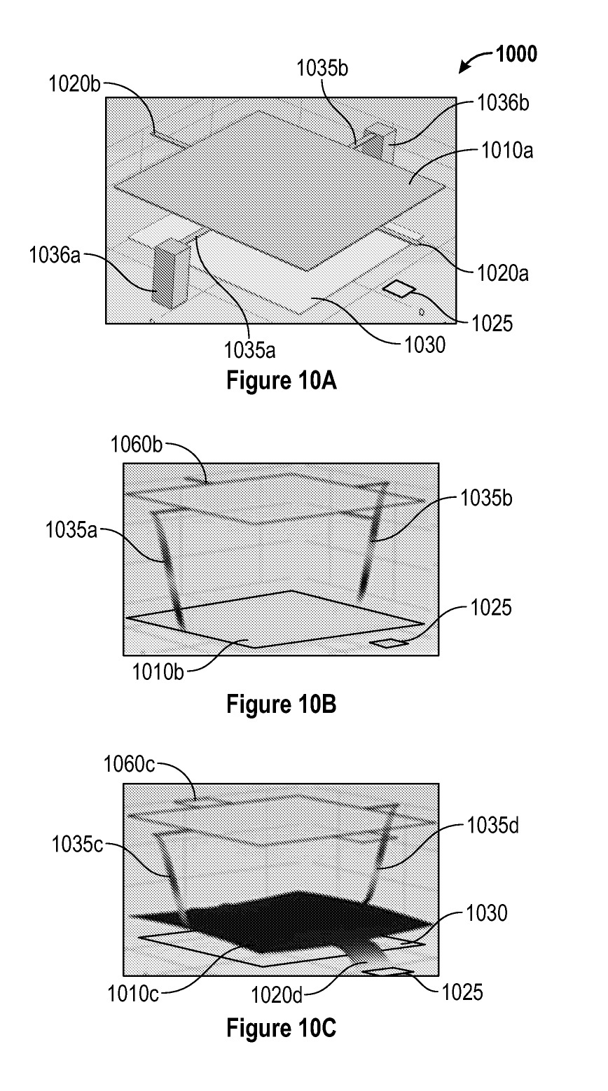

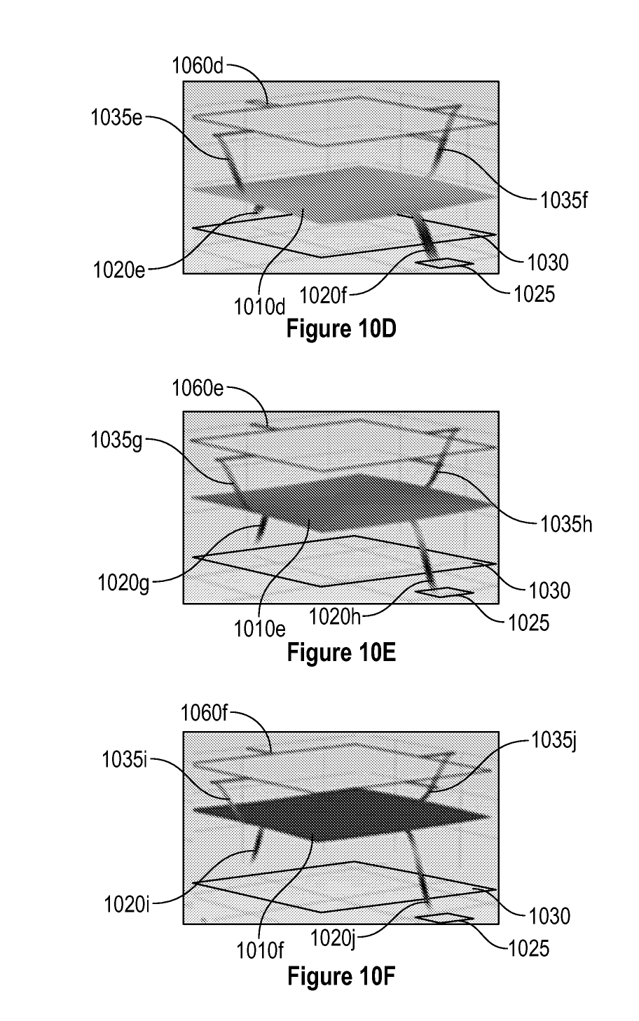

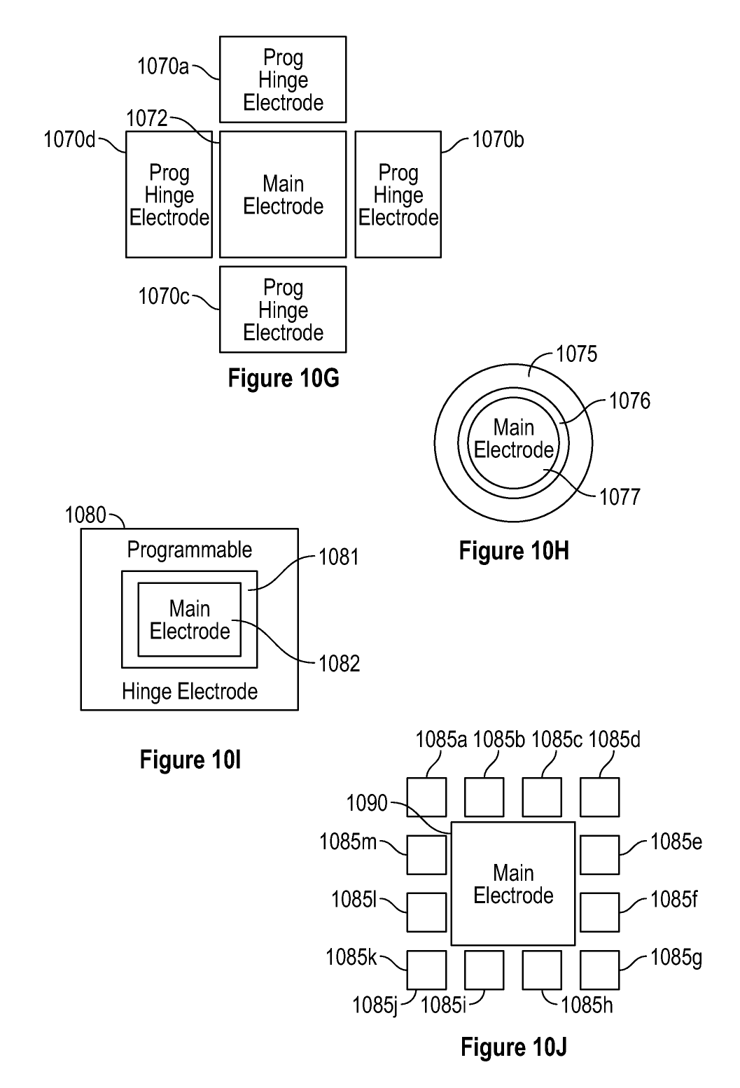

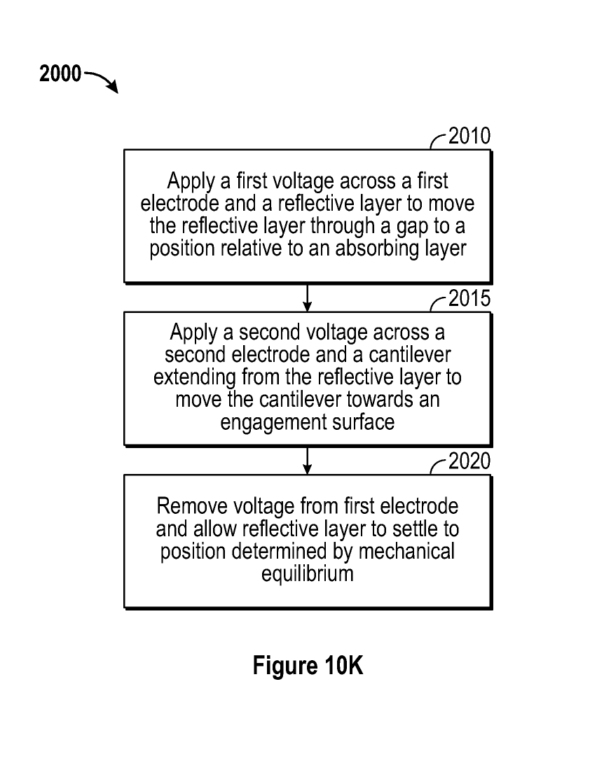

FIG. 10A shows an example implementation of a movable layer 1010a within a MEMS device 1000. In some implementations, and as discussed here, the MEMS device is an interferometric display device (IMOD) 1000. However, the disclosed technology is not limited to interferometric modulators or display devices. The movable layer 1010a is shown in FIG. 10A in a relaxed or unactuated state. The movable layer 1010a can include permanently anchored hinges 1035a and 1035b, each attached to the movable layer 1010a and a support structure. The permanently anchored hinges 1035a and 1035b can be flexible beam structures, straight or having angles/curves when in the relaxed state, and may have various stiffness characteristics depending on their dimensions, the materials they are made from, and their shape. As illustrated in FIG. 10A, the permanently anchored hinges 1035a and 1035b are attached to support posts 1036a and 1036b, respectively. The movable layer 1010a is supported above an electrode 1030 by the permanently anchored hinges 1035a and 1035b and the support posts 1036a and 1036b. The electrode 1030 illustrated here, is disposed in a plane parallel to the movable layer 1010a such that there is a gap between the movable layer 1010a and the electrode 1030.

Movable layer 1010a also includes programmable hinges 1020a and 1020b. These programmable hinges 1020a and 1020b may be considered cantilevers in that they are supported at one end by their attachment to movable layer 1010. The programmable hinges 1020a and 1020b may also be flexible beam structures, straight or having angles/curves when in the relaxed state, and may have various stiffness characteristics depending on their dimensions, the materials they are made from, and their shape. IMOD 1000 also includes at least one anchor point 1025. The anchor point 1025 may be an electrode having certain dimensions and that is positioned specifically to engage programmable hinge 1020a. Anchor point 1025 provides an engagement point for programmable hinge 1020a. In some implementations, anchor point 1025 may also be electrically connected to electrode 1030 such that they operate at approximately the same electrical potential. Alternatively, anchor point 1025 may be electrically isolated from electrode 1030 so that electrode 1030 and anchor point 1025 may be electrically controlled independent of each other. In some implementations, anchor point 1025 may be a portion of an electrode that also functions as anchor points for one or more other programmable hinges, for example, programmable hinge 1020b.

When a voltage differential is present between hinge 1020a and anchor point 1025, the hinge 1020a may be electrically attracted to the anchor point 1025. Upon contacting or otherwise engaging the anchor point 1025, the programmable hinge 1020a may exert a mechanical force on the movable layer 1010a in the general direction of the anchor point 1025. Programmable hinge 1020b may also have a corresponding anchor point (not shown). When engaged with its corresponding anchor point, the programmable hinge 1020b may also exert a mechanical force on the movable layer 1010a in the direction of its anchor point.

An electrode, such as electrode 1030 illustrated in FIG. 10A, may also exert an electrostatic force on movable layer 1010a. This electrostatic force may be sufficient to pull movable layer 1010a from its non-actuated or relaxed position illustrated in FIG. 10A towards the electrode 1030. In some implementations, this electrostatic force may be sufficient so as to pull movable layer 1010a such that it contacts electrode 1030.

The mechanical forces exerted on movable layer 1010a by programmable hinges 1020a and 1020b when engaged with their corresponding anchor points may be balanced by mechanical forces exerted on the movable layer 1010a by the permanently anchored hinges 1035a and 1035b. This balance of forces may cause a displacement of the movable layer 1010a relative to, for example, the electrode 1030.

FIG. 10B shows how a movable layer within an interferometric modulator may be designed to be positioned at different locations within an IMOD device. The location of the movable layer may be based on the balance of mechanical forces exerted on the movable layer by permanent and programmable hinges. Alternatively, the position of movable layer 1010b within a gap of an interferometric modulator may be based on the balance of forces between the permanently anchored hinges and an electrode.

FIGS. 10B-10F show a movable layer 1010b-f variably positioned within an IMOD device. When in a non-actuated state, the movable layer 1010b-f may be at a position represented by non-actuated positions 1060b-f. For example, at the non-actuated positions 1060b-f, the movable layers of FIGS. 10B-10F may be in a position similar to the position of movable layer 1010a illustrated in FIG. 10A. In FIG. 10B, the movable layer 1010b is in a fully actuated position. In some implementations, the fully actuated position may be the result of voltages applied to the movable layer 1010b and any stationary electrode used to pull the movable layer 1010b into actuation. However, in FIGS. 10C-10F, various intermediate actuations positions are illustrated using programmable hinges with differing mechanical properties. For example, in some implementations, a wide programmable hinge may exert a larger downward force on the movable layer when the programmable hinge is engaged compared to a programmable hinge that is less wide. Hence, in such implementations, when a relatively wide programmable hinge is engaged, the movable layer 1010b will define a relatively small gap compared to a relatively thin programmable hinge.

When actuated, the position of the movable layer determines the wavelength of light that may be reflected by the IMOD device. This is illustrated by the surface of each movable layer 1010b, 1010c, 1010d, 1010e, and 1010f being a different shade of gray. Movable layers 1010b, 1010c, 1010d, 1010e, and 1010f also show permanently attached hinges 1035a-j and programmable hinges 1020d-j. The programmable hinges 1020d-j are shown in an actuated or engaged state. The programmable hinges are actuated when they are fully attracted to their anchor point or electrode. The anchor point may be a fixed point on a structure of the IMOD device. Alternatively, an anchor point may be a larger structure such as an electrode. Each programmable hinge may have its own anchor point. Alternatively, more than one programmable hinge may be actuated by the same anchor point, for example, to an electrode. An electrostatic force between an anchor point and a programmable hinge may cause the programmable hinge to be attracted to the anchor point, and thereby be in an actuated state. The anchor points in FIG. 10B is electrode 1025

While the programmable hinges may be electrostatically attracted to their anchor points, they need not physically contact the anchor point or reach a distance from the anchor point sufficient to electrically short the programmable hinge with the anchor point. The electrical gap maintained between the programmable hinges and their respective anchor points may be designed such that a holding voltage sufficient to fully engage the programmable hinges towards the one or more electrodes or anchor points is below a voltage threshold. The electrical gap may also be designed such that the programmable hinges are separated from their respective electrodes by a distance that may be necessary to reduce the possibility of dielectric breakdown. The dielectric in some implementations may be Aluminum Oxide and have a thickness of between 10 nm and 50 nm.

FIG. 10B shows movable layer 1010b displaced from quiescent position 1060a to a “full down” position. This displacement may be accomplished in some implementations by an electrostatic force between the movable layer 1010a and an electrode below the movable layer (not shown), similar to the electrode 1030 illustrated in FIG. 10A. FIG. 10C shows the movable layer 1010c displaced from quiescent position 1060c, and slightly higher than the position of movable layer 1010b in FIG. 10B. The position of the movable layer 1010c in FIG. 10C is the result of the balance of mechanical forces provided by the permanently anchored hinges 1035c and 1035d and the relatively wide programmable hinges 1020c and 1020d (1020c not shown). These hinges may be electrostatically attracted or electrostatically pinned to an electrode, such as electrode 1025. The magnitude of the downward forces applied to movable layer 1010c by the programmable hinges 1020c, and 1020d may be strong enough to partially overcome the upwards forces being applied by the permanently anchored hinges 1035c and 1035d. This causes the displacement of movable layer 1010c in the direction of force exerted by the programmable hinges until the mechanical forces of all hinges reach equilibrium. Note that in FIG. 10C, there may be no electrostatic force between electrode 1030 and movable layer 1010c.

FIG. 10D shows movable layer 1010d displayed from non-actuated position 1060d and at a relatively higher position than movable layer 1010c in FIG. 10C. In the example shown in FIG. 10D, the force applied by the programmable hinges 1020e and 1020f, which may be electrostatically attracted or even electrostatically pinned to electrodes, such as electrode 1025, may be relatively smaller than the force being applied by the programmable hinges 1020c and 1020d in FIG. 10C. In the illustrated implementation, this is because the width of programmable hinges 1020e and 1020f is less than the width of programmable hinge 1020c and 1020d of FIG. 10C. The reduced mechanical force provided by the programmable hinges 1020e and 1020f when electrostatically attracted or electrostatically pinned to one or more electrodes, such as electrode 1025, may result in less displacement of movable layer 1010d from non-actuated position 1060d such that it occupies a higher position relative to the position of movable layer 1010c in FIG. 10C. Note that in FIG. 10D, there may be no electrostatic force between electrode 1030 and movable layer 1010d.

FIG. 10E shows movable layer 1010e displaced from non-actuated position 1060e at a position relatively higher still than the position of movable layer 1010d in FIG. 10D. Programmable hinges 1020g and 1020h are exerting less force on movable layer 1010e when compared to the force applied by programmable hinges 1020e and 1020f on movable layer 1010d in FIG. 10D. In the illustrated implementation, the programmable hinges 1020g and 1020h are thinner still than programmable hinges 1020e and 1020f. This results in movable layer 1010e being higher relative to movable layer 1010d, because the programmable hinges 1020g and 1020h exert less force on movable layer 1010e when electrostatically attracted or pinned to one or more electrodes, such as electrode 1025. Note also that in FIG. 10E, there may be no electrostatic force between electrode 1030 and movable layer 1010e.

FIG. 10F shows movable layer 1010f displaced from non-actuated position 1060f at a higher position relative to movable layers 1010b through 1010e. Programmable hinges 1020i and 1020j are the thinnest of programmable hinges 1020a through 1020j in the illustrated implementation, and hence exert the least mechanical force on their corresponding movable layer (movable layer 1010f) when electrostatically attracted or electrostatically pinned to one or more electrodes such as electrode 1025. Note also that in FIG. 10F, there may be no electrostatic force between electrode 1030 and movable layer 1010f.

FIGS. 10B-10F illustrate that implementations of IMOD devices using the disclosed apparatus may vary the position of a movable layer within an IMOD device by designing the mechanical properties of the permanently anchored mechanical hinges and the mechanical properties of the programmable hinges to exert a particular balance of forces on the movable layer when the programmable hinges are actuated. This force may be controlled, for example, by the width of the programmable hinges. Alternatively, the material of the mechanical hinges may be varied to provide an appropriate force. The length of the programmable hinges may also affect the amount of mechanical force exerted on the movable layer when the programmable hinges are actuated. In short, the width, material, and length of the permanently anchored mechanical hinges may effect the position of the movable layer when the programmable hinges are actuated.

FIGS. 10G-J illustrate plan views of four implementations of a main electrode and programmable hinge electrodes. In particular, FIG. 10G illustrates a main electrode 1072 that may exert an electrostatic force on a movable layer, such as movable layer 1010 in FIG. 10A, to pull the movable layer towards the main electrode. Main electrode 1072 may be similar to electrode 1030 illustrated in FIG. 10A. On each side of main electrode 1072 is one of four programmable hinge electrodes 1070a, 1070b, 1070c, and 1070d. The programmable hinge electrodes may be anchor points for one or more programmable hinges attached to a movable layer, such as movable layer 1010 of FIG. 10A. Each programmable hinge electrode or anchor point may be electrically isolated from main electrode 1072, so that the actuation or engagement of programmable hinges attached to a movable layer may be independent from an electrostatic force exerted on the movable layer by main electrode 1072. Alternatively, programmable hinge electrodes 1070a, 1070b, 1070c, and 1070d may be electrically connected to main electrode 1072.

FIG. 10H represents another implementation of a main electrode 1077 and a programmable hinge electrode 1075. Main electrode 1077 may be electrically isolated from programmable hinge electrode 1075 by an isolation layer 1076. The isolation layer may include a patterned gap on a substrate. Alternatively, the isolation layer may be comprised of an isolation material known in the art. As can be observed in FIG. 10H, the main electrode 1077 and programmable hinge electrode 1075 are of a generally circular shape, with main electrode 1077 substantially surrounded by programmable hinge electrode 1075.

Programmable hinge electrode 1075 may engage one or more programmable hinges attached to a movable layer. For example, application of a first voltage potential between the programmable hinge electrode 1075 and a movable layer, such as movable layer 1010 of FIG. 10A may selectively engage a first set of programmable hinges. These hinges may have an engagement surface area large enough to cause a sufficient electrostatic force between programmable hinge electrode 1075 and the first set of programmable hinges such that the first set of programmable hinges engages with the programmable hinge electrode 1075. In some implementations, the programmable hinges may contact the programmable hinge electrode 1075. When engaged, this first set of programmable hinges may exert a mechanical force on the movable layer to which they are attached. This mechanical force may be balanced by a mechanical force exerted in approximately the opposite direction by one or more permanently anchored hinges, also attached to the movable layer.

Upon application of a second voltage potential between programmable hinge electrode 1075 and a movable layer (not shown), that is above a second threshold, a second set of programmable hinges attached to the movable layer may engage with programmable hinge electrode 1075. This second set of programmable hinges may include the first set of programmable hinges. This second set of programmable hinges may also include additional programmable hinges beyond the hinges in the first set of programmable hinges. This larger set of programmable hinges may exert a larger mechanical force on the movable layer than was exerted on the movable layer when the first voltage potential was applied.

A third voltage potential may also be applied between programmable hinge electrode 1075 and a movable layer. This third voltage potential may be above a third voltage threshold. This may cause a third set of programmable hinges attached to a movable layer to engage with the electrode 1075, exerting a mechanical force on the movable layer to which they are attached.

FIG. 10I shows an implementation with an electrode configuration similar to FIG. 10H, except that the electrodes are substantially rectangular in shape. Main electrode 1082 is substantially surrounded by programmable hinge electrode 1080. Isolation area 1081 is disposed between main electrode 1082 and programmable hinge electrode 1080 and may include a gap or isolation materials as described above. Main electrode 1082 may also exert an electrostatically attractive force on a movable layer, such as movable layer 1010 of FIG. 10A. In some other implementations, main electrode 1082 may exert an electrostatically repulsive force on the movable layer.

FIG. 10J shows another implementation of a main electrode 1090 and programmable hinge electrodes or anchor points 1085a-m. This implementation differs from the illustrated implementations of FIGS. 10G-I in that a larger number of programmable hinge electrodes or anchor points are provided. Each of programmable hinge electrodes 1085a-m may be electrically isolated from each other and from main electrode 1090. In these implementations, individual control of programmable hinges attached to a movable layer may be provided by the electrically isolated programmable hinge electrodes 1085a-m.

In some other implementations, two or more of the programmable electrodes 1085a-m may be electrically connected. For example, some implementations may electrically connect programmable electrodes so as to provide synchronous engagement of a set of programmable hinges attached to a movable layer. For example, one programmable hinge from each side of a movable layer may be engaged by a set of programmable hinge electrodes from programmable hinge electrodes 1085a-m. For example, programmable hinge electrodes 1085c, 1085f, 1085i, and 1085m may be electrically connected. When a voltage potential is applied to these electrically connected electrodes, an electrostatic force may engage corresponding programmable hinges on each side of a movable layer. Similarly, programmable hinge electrodes 1085b, 1085e, 1085h, and 1085l may be electrically connected. When a voltage potential is applied to these electrically connected electrodes, an electrostatic force may engage corresponding programmable hinges on each side of a movable layer (not shown).

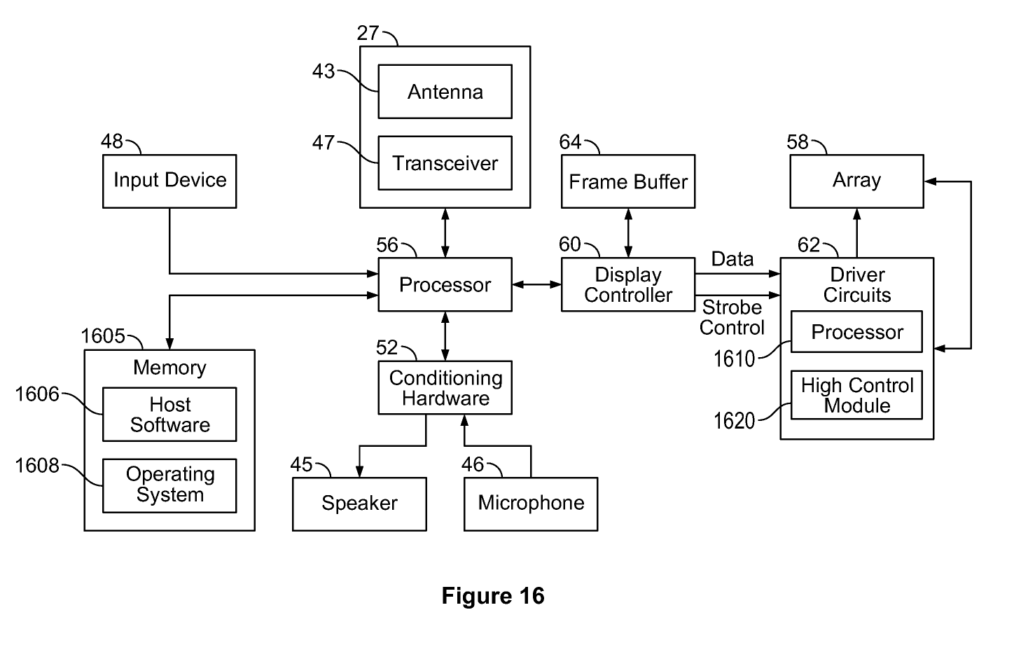

FIG. 10K is a flowchart of a method for displaying information. Process 2000 may be implemented by the data driver 210 discussed with reference to FIG. 2 and FIG. 6. Process 2000 may also be implemented by instructions included in the hinge control module 1620 or display controller 60, discussed later with reference to FIG. 16. In block 2010 of process 2000, a first voltage is applied across a first electrode and a movable reflective layer to move the movable layer through a gap to a position relative to an absorbing layer. For example, in some implementations, processing block 2010 may cause a reflective movable layer, such as movable layer 1010a illustrated in FIG. 10A, to be attracted to electrode 1030.

In block 2015, a second voltage is applied across a second electrode and a cantilever extending from the reflective layer to move the cantilever towards an engagement surface. In some implementations, block 2015 may cause a programmable hinge, which may be considered a cantilever, to move towards an electrode. In some implementations, the programmable hinge may become electrostatically pinned to the engagement surface. In these implementations, current flow between the programmable hinge or cantilever and the engagement surface may be prevented by coating either the programmable hinge or the engagement surface with a dielectric coating. In some implementations, the programmable hinge may bend due to being electrostatically attracted to the engagement surface, even if not touching. In such implementations, although not actually touching the engagement surface, the programmable hinge may still exert a mechanical force on the movable reflective layer down toward the absorbing layer.

FIGS. 10C-F illustrate various implementations of programmable hinges 1020d, 1020e-f, 1020g-h, and 1020i-j respectively, extended towards electrode 1025. By applying a voltage between a second electrode and the programmable hinge or cantilever, the programmable hinge may assert a mechanical force on its movable layer.

In block 2020, the voltage between the first electrode and the movable reflective layer is removed. This allows the reflective layer to settle at a position that is defined by an equilibrium between the mechanical forces acting on the reflective layer. For example, in some implementations, permanently anchored hinges may be exerting a mechanical force on the reflective layer in a first direction. The programmable hinges, which are extended towards an engagement surface, and in some cases are electrostatically pinned to the engagement surface, via processing block 2015, may be exerting a mechanical force in a second direction. In some implementations, the second direction may be substantially opposite of the first direction

The method of moving a reflective layer as implemented by process 2000 may lower the voltage required to move the reflective layer to a desired position. If the reflective layer is first moved by a first electrode, as is performed in block 2010, a smaller voltage may be used to move the cantilever towards an engagement surface or electrostatically pin the cantilever to the engagement surface in block 2015.

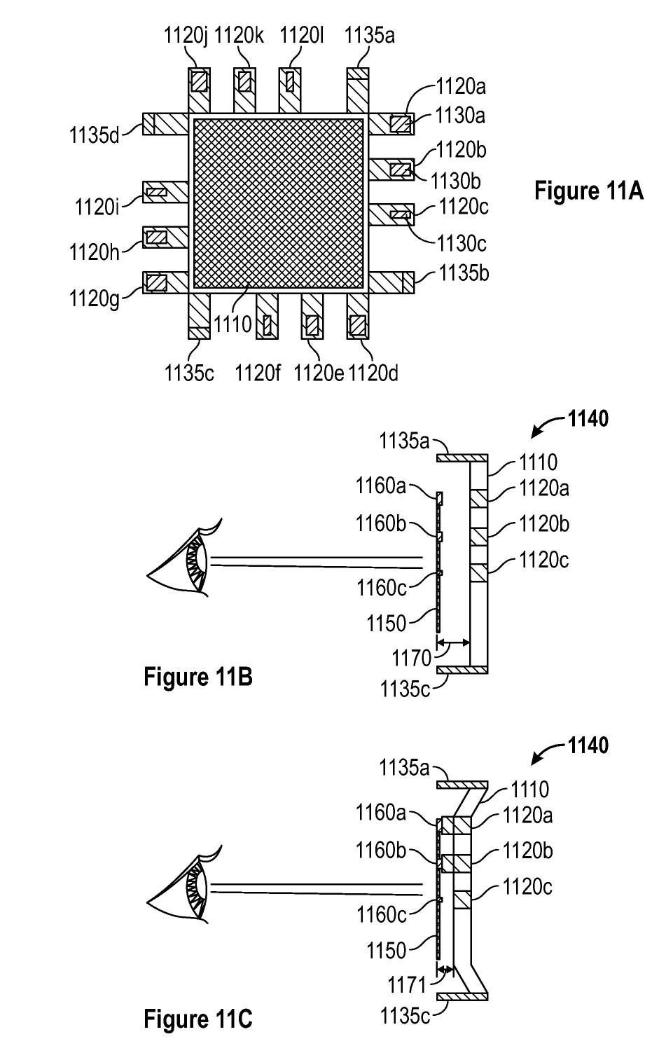

FIG. 11A shows an example implementation of a movable layer for an interferometric modulator including mechanical anchor hinges and one or more programmable hinges. Movable layers with more than one programmable hinge may be controllably positioned at more than one position within a gap of a MEMS device. The implementation of a movable layer 1110 shown in FIG. 11A includes four permanently anchored hinges 1135a, 1135b, 1135c, and 1135d. Movable layer 1110 also includes a total of twelve (12) programmable hinges 1120a-l, with three programmable hinges per side of movable layer 1110.

Mechanical forces exerted by one or more electrostatically pinned hinges 1120a-l may be balanced by forces in an approximately opposite direction exerted by the permanently anchored hinges 1135a, 1135b, 1135c, and 1135d. An equilibrium between the two forces results in a repeatable and controllable position for the movable layer 1110. This positioning method is unlike traditional analog IMODs, such as the analog IMOD illustrated in FIG. 9A. The analog IMOD of FIG. 9A, for example, relies on the balance of mechanical forces of the movable reflective layer and electrostatic forces to achieve a particular position for the movable layer 150 with the gap 910, without the use of cantilevers or programmable hinges.

Configuring movable layer 1110 with three programmable hinges per side may allow one, two, or three hinges per side to be selectively engaged to corresponding anchor points or electrodes within an IMOD device. By selectively engaging a variable number of programmable hinges, some implementations may vary the position of movable layer 1110 within an IMOD device. For example, when one programmable hinge per side of movable layer 1110 is actuated or engaged, movable layer 1110 may be at a first position within a gap. When two programmable hinges per side of movable layer 1110 are actuated or engaged, movable layer 1110 may be at a second position within a gap.

As illustrated in FIG. 11A, the engagement surfaces 1130a-c of the programmable hinges 1120a-c may vary in size. By varying the size of the engagement surface, each hinge with a particular engagement surface area may engage with an electrode or anchor point when a voltage potential between the engagement surface and the electrode crosses a particular threshold. Hinges configured with different engagement areas may engage with a programmable hinge electrode, based on the size of the hinge's engagement surface. Hinges with larger engagement areas may engage at a lower voltage potential between the engagement surface and the programmable hinge electrode than hinges with smaller engagement areas.

Some implementations provide for selective engagement of the hinges. One electric lead may connect the hinges of the movable layer electrically and may provide the programmable hinges with a variably attractive force to a programmable hinge electrode based on the size of the hinge's engagement surface. For example, note that in the implementation of a movable layer shown in FIG. 11A, the hinge with the largest engagement surface is hinge 1120a, with engagement surface 1130a. Hinge 1120a may engage with an electrode or anchor point at a lower voltage threshold than programmable hinges 1120b and 1120c, which have smaller engagement surfaces.

The number of hinges provided for a movable layer may vary based on the relative stiffness of the movable layer. For example, as both permanently anchored and programmable hinges are positioned more closely to each other around a movable layer, the movable layer may more closely maintain its quiescent shape as the hinges are engaged. This may be due to the mechanical forces being more equally balanced along the movable layer.

Alternatively, a movable layer exhibiting greater mechanical stiffness may maintain its shape as hinges are spaced further apart when compared to a movable layer exhibiting less mechanical stiffness. In some implementations, a movable layer may be disposed with two permanent anchors along opposing edges of a movable layer, and two programmable hinges along two other edges of the movable layer. In some implementations the hinges may be spaced at a distance approximating one dimension of the movable layer, (e.g., the length or width of the movable layer). In such cases, the stiffness of the movable layer's surface may maintain the layer's shape within a tolerance that provides for acceptable visual performance.

FIG. 11B illustrates the non-actuated positioning of one implementation of a movable layer relative to a visual path in some implementations of an IMOD device 1140. The movable layer 1110 may be included in the IMOD device 1140. Similar to FIG. 11A, the movable layer 1110 includes permanently anchored hinges 1135a and 1135c. In some implementations, the electrodes 1160a-c may provide an electrostatic force between the electrode and the movable layer 1110. In some implementations, the electrodes 1160a-c may provide an electrostatic force between the electrode and a programmable hinge of movable layer 1110. The movable layer 1110 is shown with programmable hinges 1120a-c in a non-actuated position. In the non-actuated position, the balance of mechanical forces provided by permanently anchored hinges 1135a-b results in a distance between the movable layer 1110 and the substrate 1150 shown by gap 1170.

FIG. 11C illustrates the positioning of one implementation of a movable layer relative to a visual path when programmable hinges of the movable layer are engaged by two electrodes. The movable layer 1110 is shown with two of its programmable hinges 1120a-b engaged with electrodes 1160a-b respectively. Note that while the programmable hinges 1120a-b may appear to be in contact with electrodes 1160a-b, an electrical gap of sufficient distance to avoid electrical shorting is maintained.

The programmable hinges exert a force on the movable layer 1110 so as to pull it towards the electrodes 1160a-b. The balance of mechanical forces between the programmable hinges 1120a-b and permanently anchored hinges 1135a-b results in a distance between the movable layer 1110 and the substrate 1150 shown by gap 1171. The distance between the movable layer 1110 and electrode 1150 changes between FIG. 11B and FIG. 11C. This can be observed by comparing gap 1170 with gap 1171. This change in the gap may change the wavelengths of light reflected by the IMOD device 1140.

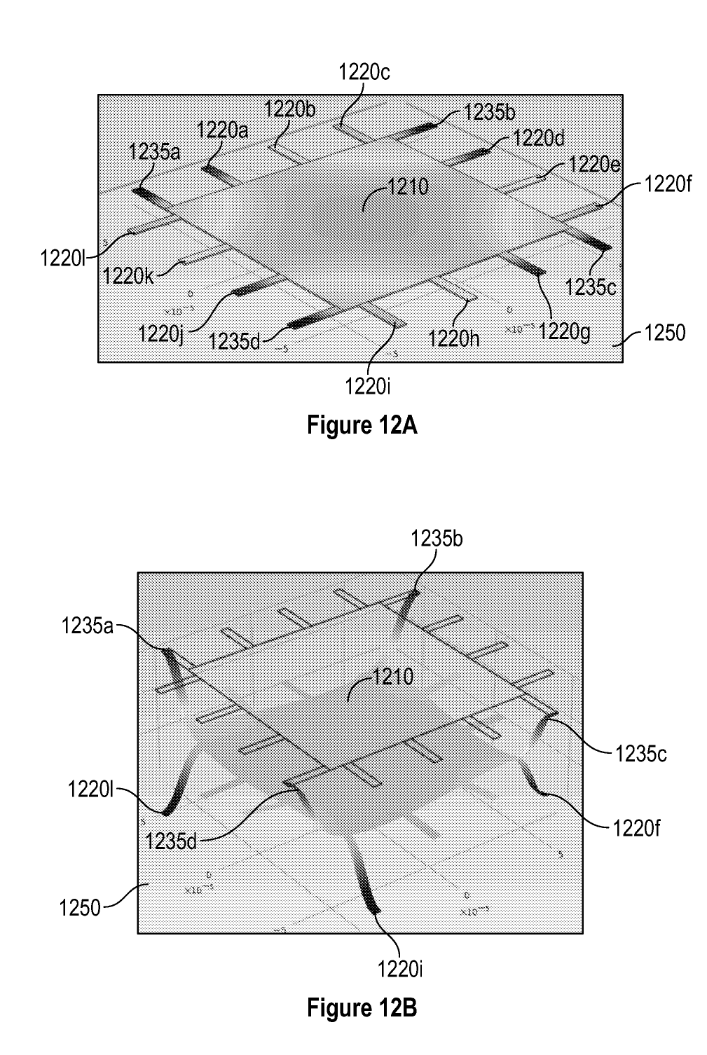

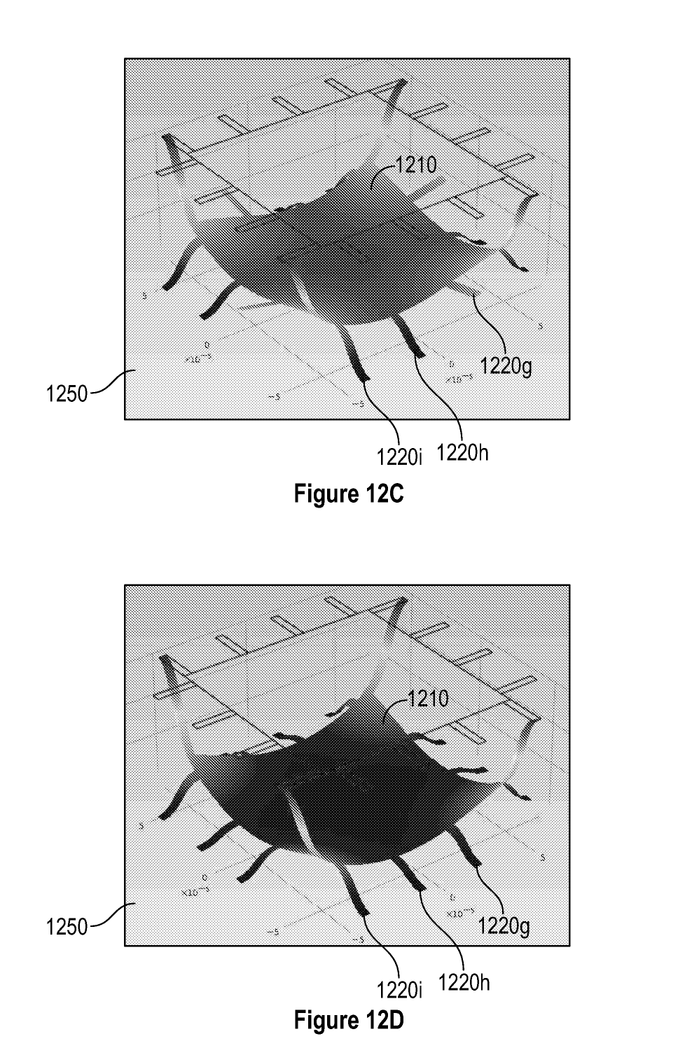

FIGS. 12A-12D show an example implementation of a movable layer within an interferometric modulator that includes a plurality of programmable hinges. FIG. 12A shows a movable layer with four permanently anchored hinges 1235a-d. Movable layer 1210 also includes twelve programmable hinges 1220a-l. In the IMOD device illustrated in image (a), none of the programmable hinges 1220a-l are actuated. That is, none of the programmable hinges 1220a-l are attracted to their anchor points by an electrostatic force sufficient to cause them to exert a mechanical force on the movable layer 1210 in the direction of their anchor points. Instead, as illustrated, the position of the movable layer 1210 in FIG. 12A is primarily related to the mechanical forces exerted on the movable layer 1210 by the permanently anchored hinges 1235a-d. As illustrated, movable layer 1210 is positioned above electrode 1250.

FIG. 12B shows the movable layer 1210 with one set of programmable hinges, hinges 1220c (not shown), and hinges 1220f, 1220i, and 1220l actuated such that they exert a mechanical force in the direction of their anchor points on movable layer 1210. Non-actuated programmable hinges are not identified in image (b) for clarity purposes, but are also observable. The hinges 1220c (not shown), 1220f, 1220i, and 1220l may be actuated by applying a first voltage potential that is above a first threshold between the programmable hinges and an electrode 1250. Note that the voltage potential may also exist between non-actuated hinges 1220a and 1220b, 1220d and 1220e, 1220g and 1220h, and 1220j and 1220k and electrode 1250. However this voltage potential may not be strong enough to cause these programmable hinges to engage with their anchor points or electrode 1250. For example, if the engagement surface of non-actuated hinges 1220a-b, 1220d-e, 1220g-h, and 1220j-k is smaller than the engagement surface of programmable hinges 1220c (not shown) and hinges 1220f, 1220i, and 1220l, a voltage above a first threshold, but below another threshold, may actuate hinges 1220c, 1220f, 1220i, and 1220l without actuating hinges 1220a-b, 1220d-e, 1220g-h, and 1220j-k.

As a result of the actuation of hinges 1220c, 1220f, 1220i, and 1220l, the movable layer 1210 is displaced relative to the location of movable layer 1210 in FIG. 12A. The programmable hinges 1220c, 1220f, 1220i, and 1220l pull movable layer 1210 down towards electrode 1250 or their anchor points until an equilibrium is reached between the mechanical force exerted by the programmable hinges and the mechanical force exerted by the permanently anchored hinges 1235a-d. Because movable layer 1210 is in a different position within the IMOD device relative to movable layer 1210 of FIG. 12 (a), a different color is reflected by the IMOD device of FIG. 12B. This is illustrated by the difference in shading between movable layer 1210 of FIG. 12A and movable layer 1210 of FIG. 12B.

FIG. 12C illustrates the movable layer 1210 with two of three programmable hinges on each side actuated. For example, programmable hinges 1220i and 1220h are actuated, while programmable hinge 1220g is not actuated. Each side of movable layer 1210 is similarly disposed with two of three programmable hinges actuated. The programmable hinges on these other three sides are not labeled to preserve image clarity. Two programmable hinges per side of movable layer 1210 may be actuated by application of a second voltage potential that is above a second threshold between the actuated programmable hinges, such as programmable hinges 1220h-i, and anchor points or a bottom electrode 1250. This voltage potential may also be present between the unactuated hinges, such as hinge 1220g, and an anchor point or electrode 1250. The second voltage that crosses a second threshold may actuate hinges 1220h-i while not actuating hinge 1220g, for example, because the second voltage potential may not be sufficient to cause sufficient electrostatic force between hinge 1220g and an anchor point or electrode. This may be the result of programmable hinge 1220g having a smaller engagement surface than programmable hinges 1220h-i.

The two actuated programmable hinges on each side of movable layer 1210, such as hinges 1220g-h, exert more downward force on movable layer 1210 than the one programmable hinge per side that is actuated on the movable layer 1210 illustrated in FIG. 12B. This results in the movable layer 1210 of FIG. 12C being positioned relatively lower in the IMOD device than the movable layer 1210 of FIG. 12B. The two actuated programmable hinges per side in FIG. 12C pull the movable layer closer to their anchor points (not shown) than the one programmable hinge per side of FIG. 12B. This change in relative position of the movable layer causes a different wavelength of light to be reflected by the IMOD device of FIG. 12C. This is illustrated by the different shading of movable layer 1210 of FIG. 12C when compared to the shading of the movable layer 1210 of FIG. 12B.

FIG. 12D shows the movable layer 1210 with three actuated programmable hinges per side. One side is illustrated with hinges 1220g-i in an actuated state. The programmable hinges on other sides of movable layer 1210 are not labeled for figure clarity but can be observed in the actuated position. Actuation of the three programmable hinges per side may be performed by application of a third voltage potential between the hinges 1220g-i and an anchor point or electrode, such as electrode 1250.

The three actuated programmable hinges on each side of movable layer 1210 in FIG. 12D exert more downward force on movable layer 1210 than the two programmable hinges per side that are actuated on the movable layer 1210 illustrated in FIG. 12C. This results in the movable layer 1210 of FIG. 12D being positioned still lower in the IMOD device than the movable layer 1210 of FIG. 12C. This change in relative position of the movable layer causes a different wavelength of light to be reflected by the IMOD device of FIG. 12D when compared to the IMOD device of FIG. 12C or FIG. 12B. This is illustrated by the different shading of movable layer 1210 of FIG. 12D when compared to the shading of the movable layer 1210 of FIG. 12B or FIG. 12C.

As demonstrated by FIGS. 12A-D, the disclosed movable layer with a variable number of engaged programmable hinges may provide an IMOD capable of having multiple states. At each of these states, the movable layer may be at a discrete distance from an electrode that is different from any of the other states. For example, an IMOD may be in a first state illustrated in FIG. 12A, where the movable layer is a first distance from an electrode. The IMOD may have a second state illustrated by FIG. 12B, with the movable layer at a second distance from an electrode. The IMOD may have a third state illustrated by FIG. 12C, with its movable layer at a third distance from the electrode. The IMOD may also have a fourth state illustrated by FIG. 12D, with its movable layer at a fourth distance from an electrode. The IMODS utilizing the movable layer design of FIGS. 12A-D are not limited to four states, and may have, for example, 5, 10, 25, 100 different states, and with each state a movable layer having a different distance from an electrode than any other state.

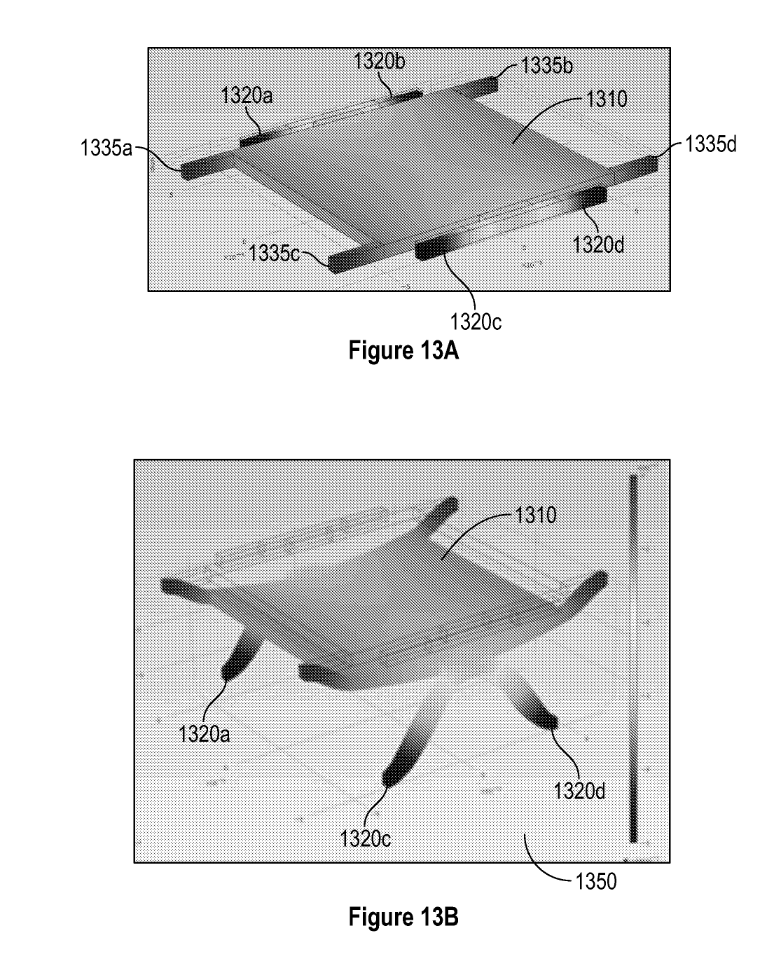

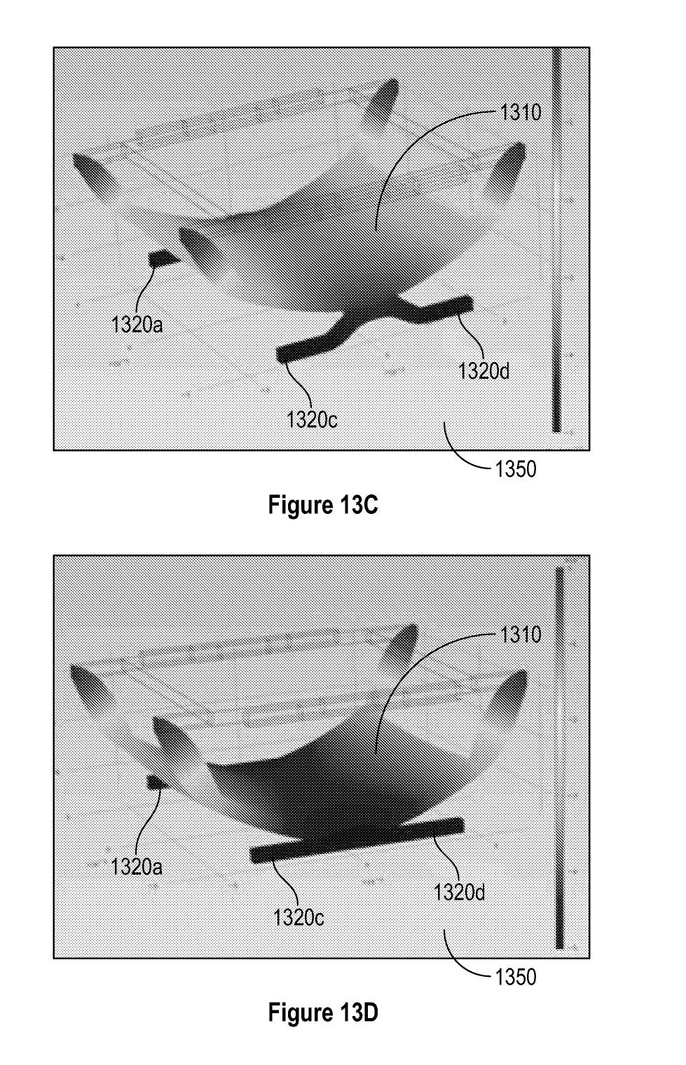

FIGS. 13A-13D show an example implementation of a movable layer that includes programmable hinges providing multiple engagement points per hinge. In the illustrated implementation of a movable layer, a programmable hinge may be provided that variably engages with an anchor point or electrode. Movable layer 1310 also includes four permanently anchored hinges 1335a-d. FIG. 13A illustrates a movable layer 1310 with variably engageable hinges 1320a-d at a non-actuated position. FIG. 13B illustrates the movable layer 1310 with the variably engageable hinges 1320a-d at a first position. The hinges 1320a-d are engaged with an electrode 1350. The engagement of hinges 1320a-d at a first position may be performed by application of a first voltage potential between the programmable hinges 1320a-d and the electrode 1350. The first voltage may be above a first threshold. FIG. 13C illustrates a movable layer with variably engageable hinges 1320a-d at a second position. An increase in voltage potential between electrode 1350 and the programmable hinges 1320a-d to a voltage level above a second threshold may cause the hinge to further engage with the electrode 1350. FIG. 13D illustrates the movable layer 1310 after a further increase in voltage potential above a third threshold between the programmable hinges 1320a-d and electrode 1350. The movable layer moves down as the hinges 1320c-d “zip up” with the electrode 1350 due to increasing voltage potential between the programmable hinges 1320a-d and the electrode 1350.

Similar to the IMOD design illustrated in FIGS. 12A-D, IMODs utilizing the design of FIGS. 13A-D may also have multiple states, with each state maintaining a different distance between the movable layer and an electrode. IMODS utilizing this design are also not limited to the specific states shown or the number of states shown. Some implementations of the design shown in FIGS. 13A-D may have an infinitely variable number of states, or a discrete number of states, based on the voltage applied between the electrode and the programmable hinges. In the illustrated implementation, the IMOD has three states other than the non-actuated state shown in FIG. 13A. More generally, an analog IMOD can be considered to be an IMOD with two or more states other than the non-actuated state. In some implementations using the cantilever designs disclosed herein, an analog IMOD can be considered to be an IMOD with two, three, or four states other than the non-actuated state.

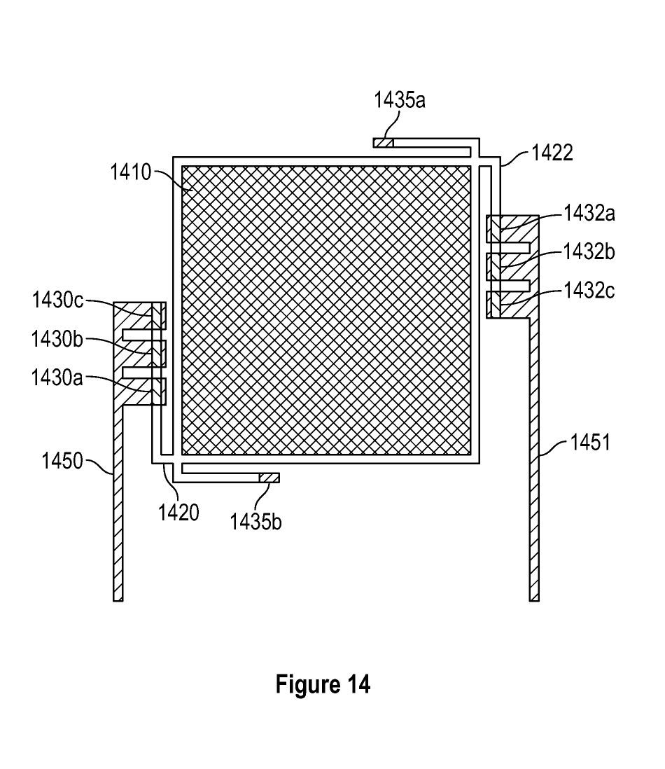

FIG. 14 shows a top-down view of an example implementation of a movable layer providing programmable hinges with lower segmented electrodes for variably engaging each of the programmable hinges. In the illustrated implementation, only two permanently anchored hinges 1435a-b and two programmable hinges 1420 and 1422 are provided. IMOD devices utilizing movable layers that rely on the balance of mechanical forces to determine their position within a gap may experience less tilt instability in their movable layers than IMOD devices relying on both electrostatic forces and mechanical forces. For example, the IMOD design shown in FIG. 9A may exhibit more tilt instability than an IMOD using the movable layer shown in FIG. 12. This reduced tilt instability when compared to IMOD devices relying on both electrostatic forces and mechanical forces may enable the use of a movable layer including two permanently anchored hinges and two programmable hinges. This design may also improve fill factor of the IMOD device. The design may also simplify the design of electrical routing to support the programmable hinges.

The two programmable hinges of the movable layer 1410 may be selectively engaged with one or more anchor points such as a segmented electrode by application of a voltage between the programmable hinges and the segmented electrode. The different segments of the segmented lower electrodes 1450 and 1451 can provide engagement surfaces or segments 1430a-c and 1432a-c, respectively, for variably engaging the programmable hinges. These engagement surfaces may be of varied size or area. For example, segments 1430a and 1432a may have an equivalent area, with segments 1430b and 1432b also having an equivalent area that is different than the area of 1430a and 1432b. Similarly, segments 1430c and 1432c may also share a common area or size which is also different than segments 1430a-b and 1432a-b. Selective engagement of the segments 1430a-c and 1432a-c of programmable hinges 1420 and 1422 may determine the effective free length of the programmable hinges 1420 and 1422. Changing the effective free length of the programmable hinges may change the position of movable layer 1410 within an IMOD device.

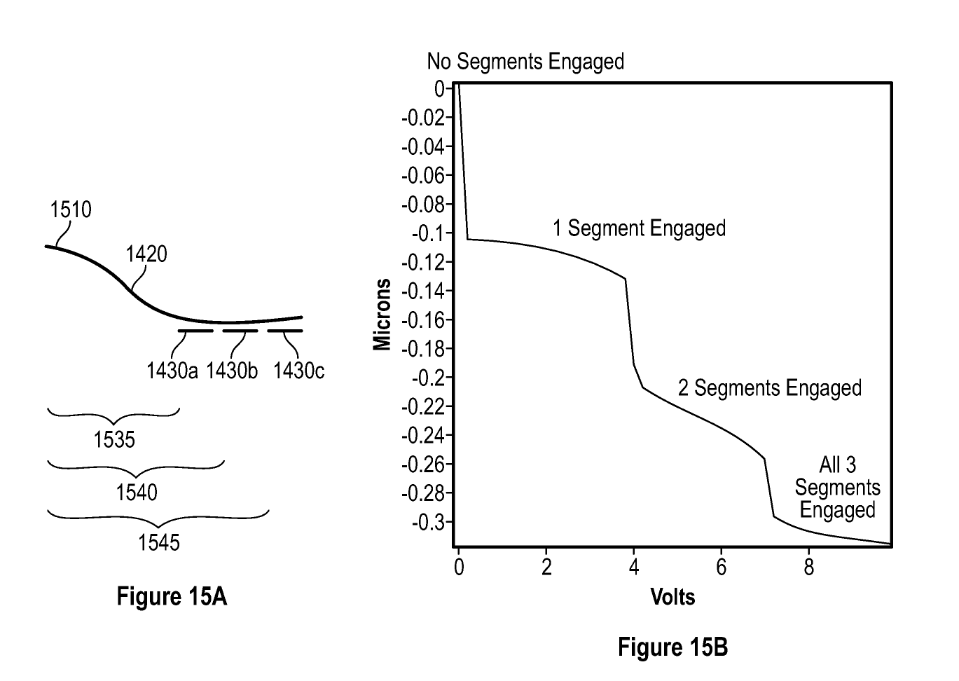

FIG. 15A shows multiple different anchor points within a programmable hinge. FIG. 15B shows the relative displacement of a movable layer when engaging different anchor points within a programmable hinge. Specifically FIG. 15A shows a cross section of programmable hinge 1420 of FIG. 14. For example, hinge 1420 may be connected to a movable layer and counteract permanently anchored hinges at position 1510. At the opposite end of hinge 1510 are three segments 1430a-c of segmented lower electrode 1450. These three segments provide for selective engagement of hinge 1420. For example, when only segment 1430c is engaged, the effective free length of hinge 1420 may be represented by bracket 1545. When segments 1430b and 1430c are both engaged, the effective free length of hinge 1420 may be reduced to that represented by bracket 1540. When segments 1430a-c are engaged, the effective free length of hinge 1420 may be reduced further to that represented by bracket 1535.

FIG. 15B shows the displacement of a movable layer 1410 in an example implementation when segments 1430a-c are selectively engaged to change the effective free length of programmable hinges 1420. For example, when no segments are engaged, FIG. 15B illustrates that the movable layer 1410 has a displacement of zero (0) from its non-actuated position. When one segment is engaged, a displacement of −0.12 microns is achieved. Two segments provide approximately −0.24 microns of engagement while engaging three segments provides −0.3 microns of engagement. The ability to change the displacement of a movable layer within an IMOD device may enable the IMOD device to reflect different wavelengths of light at each displacement.

FIG. 16 is an example system block diagram illustrating a visual display device 40 including a plurality of interferometric modulators. The display device 40 can be, for example, a cellular or mobile telephone. However, the same components or slight variations thereof are also illustrative of various other types of display devices such as televisions, laptop or notebook computers, and portable media players.

The display device 40 may include a housing, a display array 58, an antenna 43, a speaker 45, an input device 48, and a microphone 46. The housing may generally formed from any of a variety of manufacturing processes, including injection molding, and vacuum forming. In addition, the housing may be made from any of a variety of materials, including but not limited to plastic, metal, glass, rubber, and ceramic, or a combination thereof. In one implementation the housing includes removable portions that may be interchanged with other removable portions of different color, or containing different logos, pictures, or symbols.

The display array 58 of display device 40 may be any of a variety of displays including a bi-stable display, or interferometric modulator display as described herein. In other implementations, the display 58 includes a flat-panel display, such as plasma, EL, OLED, STN LCD, or TFT LCD as described above, or a non-flat-panel display, such as a CRT or other tube device.

The illustrated display device 40 can include additional components associated therewith. For example, in one implementation, the display device 40 includes a network interface 27 that includes an antenna 43 which is coupled to a transceiver 47. The transceiver 47 is connected to a processor 56, which is connected to conditioning hardware 52. The conditioning hardware 52 may be configured to condition a signal (such as filter a signal). Conditioning hardware 52 generally includes amplifiers and filters for transmitting signals to the speaker 45, and for receiving signals from the microphone 46. Conditioning hardware 52 may be discrete components within the display device 40, or may be incorporated within the processor 56 or other components.

The conditioning hardware 52 is connected to a speaker 45 and a microphone 46. The processor 56 is also connected to an input device 48 and a driver controller 29. A power supply (not shown) provides power to all components as required by the particular display device 40 design. The power supply can include a variety of energy storage devices as are well known in the art. For example, in one implementation, the power supply is a rechargeable battery, such as a nickel-cadmium battery or a lithium ion battery. In another implementation, the power supply is a renewable energy source, a capacitor, or a solar cell, including a plastic solar cell, and solar-cell paint. In another implementation, the power supply is configured to receive power from a wall outlet.

The network interface 27 includes the antenna 43 and the transceiver 47 so that the display device 40 can communicate with one ore more devices over a network. In one implementation the network interface 27 may also have some processing capabilities to relieve requirements of the processor 56. The antenna 43 is any antenna for transmitting and receiving signals. In one implementation, the antenna transmits and receives RF signals according to the IEEE 802.11 standard, including IEEE 802.11(a), (b), or (g). In another implementation, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 56. The transceiver 47 also processes signals received from the processor 56 so that they may be transmitted from the display device 40 via the antenna 43.

In an alternative implementation, the transceiver 47 can be replaced by a receiver. In yet another alternative implementation, network interface 27 can be replaced by an image source, which can store or generate image data to be sent to the processor 56. For example, the image source can be a digital video disc (DVD) or a hard-disc drive that contains image data, or a software module that generates image data.

The input device 48 allows a user to control the operation of the display device 40. In one implementation, input device 48 includes a keypad, such as a QWERTY keyboard or a telephone keypad, a button, a switch, a touch-sensitive screen, a pressure- or heat-sensitive membrane. In one implementation, the microphone 46 is an input device for the display device 40. When the microphone 46 is used to input data to the device, voice commands may be provided by a user for controlling operations of the display device 40.

The processor 56 will generally include an internal memory (not shown) for storing image data, and includes electronic processing circuitry configured to process this image data as defined by one or more software or firmware programs running on the processor 56.

The device may include a memory 1605. The memory includes software modules that include instructions for processor 56. For example, memory 1605 is illustrated as including host software 1606, and an operating system module 1608. Instructions included in these modules configure processor 56 to perform the functions of device 40.

Operating system module 1608 may include instructions that configure processor 56 to manage the hardware and software resources of device 40. Host software module 1606 may include instructions for one or more application programs that are running on the one or more processors 56 in the device. For example, instructions in one or more host software programs may configure processor 56 to control what is to be displayed on the array 58.

Although instructions in host software determine what information is displayed on array 58, direct control over the pixels of the array is generally allocated to a display controller 60 and driver circuits 62. Although illustrated as two blocks in FIG. 16, these two functions are often part of one controller integrated circuit. Display controller 60 and driver circuits 62 may correspond to the data driver 210 illustrated in FIG. 6. When controlling an analog IMOD, such as the AIMOD illustrated in FIG. 5 or FIG. 9A or FIG. 9B, the data lines DL1-DLn illustrated in FIG. 6 can be placed at a range of voltages between Vₒ and ground. The voltage level asserted on data lines DL1-DLn may cause the movable layers within the analog IMODs to be independently placed in any particular desired position. As described above, the data driver 210 may convert pixel data values to voltages to place the pixels of the array in the state desired by the host software.

When controlling an analog IMOD including a movable layer with one or more programmable hinges, such as the analog IMOD illustrated in FIG. 10A-F, 12A-D, or 13A-D, the driver circuits 62 may also include a processor 1610 and a hinge control module 1620. Hinge control module 1620 may include instructions that configure processor 1610 to perform array driving functions. For example, hinge control module may include instructions that configure processor 1610 to determine an engagement characteristic of one or more cantilevers and/or a movable layer.

For example, instructions may configure processor 1610 may determine how many programmable hinges or cantilevers attached to the movable layer will be engaged with one or more electrodes. This decision may be based, at least in part, on image data defining pixel values corresponding to the location of one or more IMODs in a display panel. The processor 1610 may then selectively engage programmable hinges of movable layers within IMODs of the array 58 by varying the voltages to engage the programmable hinges as described herein.

In some implementations, for example, in implementations utilizing a movable layer and programmable hinge design illustrated in FIGS. 13A-D, instructions may configure the processor to determine an engagement characteristic such as a degree of engagement of a programmable hinge. In these implementations, instructions may determine whether a programmable hinge such as programmable hinge 1320c is configured as shown in FIG. 13B or FIG. 13C.

As the host receives and/or generates pixel data for display, it stores that data in a frame buffer 64. The host may have direct access to these memory locations, or it may access them through the display controller 60. The frame buffer 64 may be incorporated into the display controller 60. The display controller 60 reads the memory locations that constitute the frame buffer, and places the data into the correct format and timing to operate the driver circuits 62.

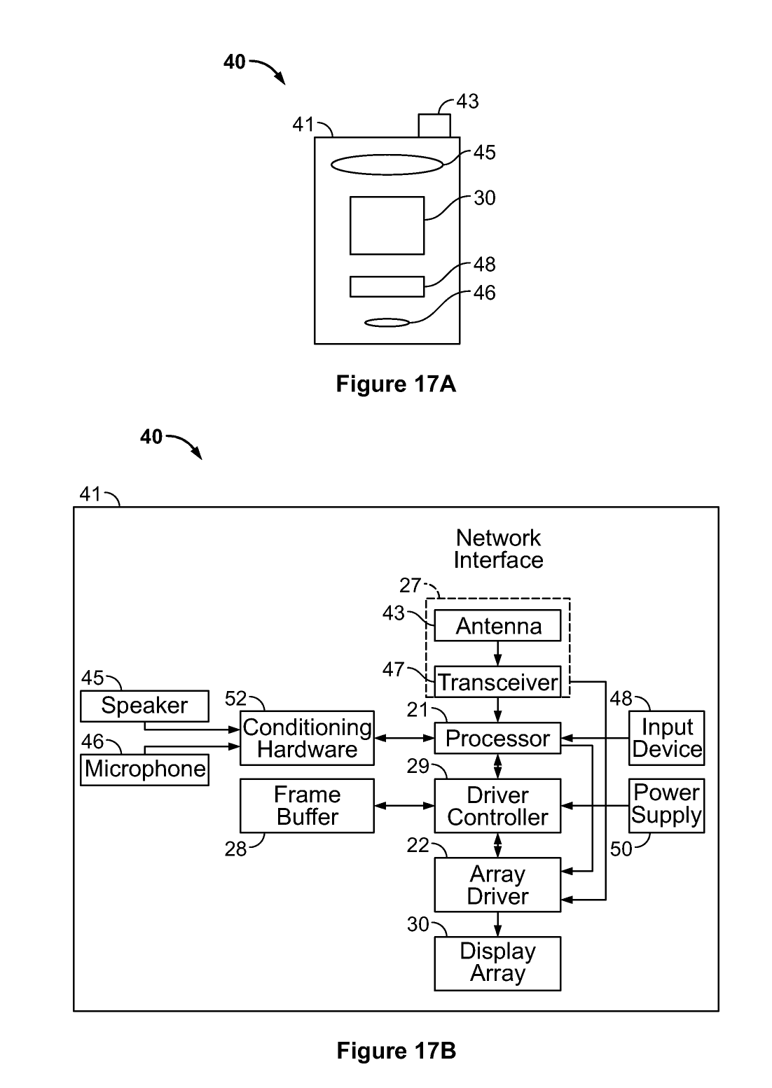

FIGS. 17A and 17B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 19B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (such as, filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, such as the data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An electromechanical apparatus, comprising:
a movable reflective layer with at least two opposing edges, the reflective layer including at least two cantilevers, at least one cantilever extending from each of the at least two opposing edges; and
one or more electrodes for attracting the at least two cantilevers such that when a voltage is applied to the one or more electrodes, an electrostatic force moves the cantilevers toward an engagement surface and the cantilevers thereby exert a mechanical force on the movable reflective layer.

2. The electromechanical apparatus of claim 1, wherein the movable layer is configured to move within a gap, wherein a position of the movable layer within the gap determines the color of light reflected from the electromechanical apparatus.

3. The apparatus of claim 1, further comprising an absorbing layer, wherein the reflective layer is configured to move within a gap disposed between the reflective layer and the absorbing layer, wherein a distance between the reflective layer and the absorbing layer determines color of light reflected from the apparatus.

4. The apparatus of claim 1, further comprising
a plurality of supports; and
at least one hinge connected to the reflective layer and to at least one of the plurality of supports, wherein the reflective layer is held at a position by at the least one hinge.

5. The apparatus of claim 4, wherein the apparatus is configured such that the position of the reflective layer within the gap is determined, at least temporarily, by a balance of mechanical forces exerted by the at least one hinge and at least one of the cantilevers.

6. The apparatus of claim 1, further comprising an analog interferometric modulator capable of having three or more states, the analog interferometric modulator including the movable reflective layer and the one or more electrodes.

7. The apparatus of claim 1, further comprising a main electrode for actuating the movable reflective layer.

8. The apparatus of claim 1, wherein the reflective layer is substantially rectangular shaped and includes four edges, and wherein the at least two cantilevers extend from at least two of the edges of the reflective layer.

9. The apparatus of claim 1, wherein the apparatus is configured such that a first cantilever is configured to contact the engagement surface upon application of a first voltage between the first cantilever and a first electrode, and a second cantilever is configured to contact the engagement surface upon the application of a second voltage across the second cantilever and a second electrode.

10. The apparatus of claim 9, wherein the first voltage is lower than the second voltage.

11. The apparatus of claim 9, wherein the first electrode and the second electrode are the same electrode.

12. The apparatus of claim 1, wherein a first contact point on a first cantilever is configured to contact the engagement surface when a first voltage is applied across an electrode and the first cantilever, and a second contact point on the first cantilever is configured to contact the engagement surface when a second voltage is applied across the electrode and the first cantilever.

13. The apparatus of claim 12, wherein the first contact point is between the second contact point and an end of the cantilever distal to the reflective layer, and wherein the first voltage is lower than the second voltage.

14. The apparatus of claim 1, wherein the mechanical layer includes at least four cantilevers, and wherein at least two cantilevers extend from at least two of the opposing edges.

15. The apparatus of claim 1, further comprising:
an electronic display;
a processor that is configured to communicate with the electronic display, the processor being configured to process image data; and
a memory device that is configured to communicate with the processor.

16. The apparatus of claim 15, wherein the processor is configured to determine an engagement characteristic of one or more cantilevers.

17. The apparatus of claim 16, wherein the processor determines which of the one or more cantilevers will engage with the one or more electrodes or a degree of a cantilever's engagement with an electrode.

18. The apparatus of claim 1, wherein the movable layer is configured to be positioned at three or more discrete distances from an electrode.

19. The apparatus of claim 15, further comprising a driver circuit configured to send at least one signal to the display.

20. The apparatus of claim 19, further comprising a controller configured to send at least a portion of the image data to the driver circuit.

21. The apparatus of claim 15, further comprising an image source module configured to send the image data to the processor.

22. The apparatus of claim 21, wherein the image source module includes at least one of a receiver, transceiver, and transmitter.

23. The apparatus as recited in claim 15, further comprising an input device configured to receive input data and to communicate the input data to the processor.

24. A method of displaying information, the method comprising:
applying a first voltage across a first electrode and a movable reflective layer to move the movable layer through a gap to a position relative to an absorbing layer; and
applying a second voltage across a second electrode and a cantilever extending from the reflective layer to move the cantilever toward an engagement surface.

25. The method of claim 24, wherein the position of the reflective layer in the gap determines the color of light reflected from an electromechanical device.

26. The method of claim 24, further comprising stopping application of the first voltage while continuing to apply the second voltage.

27. An electromechanical apparatus, comprising:
means for applying a first voltage to a movable reflective layer to move the movable layer through a gap to a position relative to an absorbing layer; and
means for applying a second voltage to a cantilever extending from the reflective layer to move the cantilever toward an engagement surface.

28. The apparatus of claim 27, wherein the first voltage applying means includes a first electrode and a first actuation circuit, the first actuation circuit electrically connected to the first electrode and the reflective layer.

29. The apparatus of claim 27, wherein the second voltage applying means includes a second electrode and a second actuation circuit, the second actuation circuit electrically connected to the second electrode and the cantilever.

30. A non-transitory, computer readable storage medium having instructions stored thereon that cause a processing circuit to perform a method comprising:
applying a first voltage across a first electrode and a movable reflective layer to move the movable layer through a gap to a position relative to an absorbing layer; and
applying a second voltage across a second electrode and a cantilever extending from the reflective layer to move the cantilever toward an engagement surface.

31. The non-transitory, computer readable storage medium of claim 30, wherein the method further includes stopping application of the first voltage while continuing to apply the second voltage.
